(19) United States
(12) Patent Application Publication
(10) Pub. No.: US 2017/0066625 A1
(43) Pub. Date: Mar. 9, 2017

(54) ELEVATOR POSITION DETECTION APPARATUS

(71) Applicant: MITSUBISHI ELECTRIC CORPORATION, Chiyoda-ku (JP)

(72) Inventors: Akihide SHIRATSUKI, Chiyoda-ku (JP); Keita MOCHIZUKI, Chiyoda-ku (JP); Jin INOUE, Chiyoda-ku (JP); Hiroshi TAGUCHI, Chiyoda-ku (JP); Makito SEKI, Chiyoda-ku (JP); Masahiro ISHIKAWA, Chiyoda-ku (JP)

(73) Assignee: MITSUBISHI ELECTRIC CORPORATION, Chiyoda-ku (JP)

(21) Appl. No.: 15/120,472

(22) PCT Filed: Nov. 27, 2014
(86) PCT No.: PCT/JP2014/081431

§ 371 Date: Aug. 19, 2016

(30) Foreign Application Priority Data
Apr. 16, 2014 (JP) PCT/JP2014/060847

(51) Int. Cl. B66B 1/34; B66B 5/00

(52) U.S. Cl. CPC B66B 1/3492; B66B 5/0018; B66B 5/0031

(57) ABSTRACT

A detection subject body includes a first detection subject plate provided with an ID sequence and a second detection subject plate provided with a clock sequence. A detector includes a first detection unit that outputs, as an ID signal, a time series signal that switches condition in a boundary position between a first property portion and a second property portion of the ID sequence when the ID sequence passes through a first detection region, and a second detection unit that outputs, as a clock signal, a time series signal that switches condition in a boundary position between a first property portion and a second property portion of the clock sequence when the clock sequence passes through a second detection region. A processing unit specifies a position of the elevating body by reading the condition of the ID signal in a position where the condition of the clock signal switches.

### TECHNICAL FIELD

This invention relates to an elevator position detection apparatus for detecting a position of an elevating body.

### BACKGROUND ART

A conventional elevator position detection apparatus detects a landing position of a car by reading a position code of a detection subject plate using a detector that opposes, but does not contact, the detection subject plate including the position code. A plurality of code elements are provided in the detection subject plate. The position code is set in the detection subject plate by selectively providing the plurality of code elements with either a light transmitting portion or a light blocking portion. The detector reads the position code by detecting light blockage by the respective code elements (see PTL 1).

Further, a conventional elevator car position correction apparatus is configured to detect an absolute position of a car by providing a slit pattern in a landing position detection plate provided in a hoistway and detecting the slit pattern using a landing detector provided in the car. The slit pattern is formed from a combination of a plurality of slits, and different patterns are displayed in accordance with widths and numbers of the slits (see PTL 2).

### CITATION LIST

### Patent Literature

### [PTL 1]

Japanese Patent Application Publication No. H5-51178

### [PTL 2]

Japanese Patent Application Publication No. H5-43159

### SUMMARY OF INVENTION

### Technical Problem

In the elevator position detection apparatus disclosed in PTL 1, however, the plurality of code elements are arranged in both a horizontal direction and a vertical direction, and therefore a horizontal direction position of the detector relative to positions of the respective code elements of the detection subject plate must be maintained with a high degree of precision. As a result, light blockage by the code elements may be detected erroneously.

Further, in the elevator car position correction apparatus disclosed in PTL 2, the respective widths of the slits cannot be detected accurately when a speed of the car varies, and as a result, the position of the car may be detected erroneously.

This invention has been designed to solve the problems described above, and an object thereof is to obtain an elevator position detection apparatus that can detect a position of an elevating body with greater accuracy and reliability.

### Solution to Problem

An elevator position detection apparatus according to this invention includes a detection subject body that is provided in a hoistway and includes a first detection subject plate and a second detection subject plate, the first detection subject plate being provided with an ID sequence formed by arranging a first property portion and a second property portion having a different property from the first property portion in a movement direction of an elevating body in an arrangement pattern that corresponds to a position within the hoistway, and the second detection subject plate being provided with a clock sequence formed by arranging a first property portion and a second property portion having a different property from the first property portion in the movement direction of the elevating body, a detector that is provided in the elevating body and includes a first detection unit and a second detection unit, the first detection unit being provided with a first detection region so as to output, as an ID signal, a time series signal having an output condition that switches in a boundary position between the first property portion and the second property portion of the ID sequence when the ID sequence passes through the first detection region, and the second detection unit being provided with a second detection region so as to output, as a clock signal, a time series signal having an output condition that switches in a boundary position between the first property portion and the second property portion of the clock sequence when the clock sequence passes through the second detection region, and a processing unit that specifies a position of the elevating body within the hoistway by reading the output condition of the ID signal in a position where the output condition of the clock signal switches.

### Advantageous Effects of Invention

With the elevator position detection apparatus according to this invention, the condition of the ID signal can be read using the clock signal as a reference, and as a result, the position of the elevating body can be detected with greater accuracy and reliability.

### BRIEF DESCRIPTION OF DRAWINGS

FIG. 1 is a view showing a configuration of an elevator according to a first embodiment of this invention.

FIG. 2 is a perspective view showing a position detection apparatus of FIG. 1.

FIG. 3 is a graph comparing temporal variation in respective conditions of an ID signal and a clock signal output respectively by first and second detection units of FIG. 2.

FIG. 4 is a perspective view showing a detection subject body and a detector of an elevator position detection apparatus according to a second embodiment of this invention.

FIG. 5 is a perspective view showing a detection subject body and a detector of an elevator position detection apparatus according to a third embodiment of this invention.

FIG. 6 is a graph comparing temporal variation in respective conditions of an ID signal and a clock signal output respectively by first and second detection units of FIG. 5.

FIG. 7 is a view showing a configuration of an elevator according to a fourth embodiment of this invention.

FIG. 8 is a block diagram showing an elevator position detection apparatus of FIG. 7.

FIG. 9 is a view showing a configuration of a detection subject body of an elevator position detection apparatus according to a fifth embodiment of this invention.

FIG. 10 is a view showing a configuration of a detection subject body of an elevator position detection apparatus according to a sixth embodiment of this invention.

FIG. 11 is a perspective view showing a detection subject body and a detector of an elevator position detection apparatus according to a seventh embodiment of this invention.

FIG. 12 is a side view showing the detector of FIG. 11.

FIG. 13 is a graph comparing temporal variation in respective conditions of an ID signal and a clock signal output respectively by first and second detection units of FIG. 11.

FIG. 14 is a perspective view showing a detector of an elevator position detection apparatus according to an eighth embodiment of this invention.

FIG. 15 is a perspective view showing a detection subject body and a detector of an elevator position detection apparatus according to a ninth embodiment of this invention.

FIG. 16 is a graph comparing temporal variation in respective conditions of an ID signal and a clock signal output respectively by first and second detection units of FIG. 15.

FIG. 17 is a block diagram showing an elevator position detection apparatus according to a tenth embodiment of this invention.

FIG. 18 is a perspective view showing detection subject bodies and detectors of the elevator position detection apparatus of FIG. 17.

FIG. 19 is a perspective view showing detection subject bodies and detectors of an elevator position detection apparatus according to an eleventh embodiment of this invention.

FIG. 20 is a top view showing the detection subject bodies and the detectors of FIG. 19.

FIG. 21 is a front view showing the detectors of FIG. 20.

FIG. 22 is a perspective view showing a detection subject body and detectors of an elevator position detection apparatus according to a twelfth embodiment of this invention.

FIG. 23 is a top view showing the detection subject body and the detectors of FIG. 22.

FIG. 24 is a front view showing the detectors of FIG. 22.

FIG. 25 is a graph comparing temporal variation in output conditions in which ID signals and clock signals are output respectively by the detectors of FIG. 22.

FIG. 26 is a perspective view showing a detection subject body and detectors of an elevator position detection apparatus according to a thirteenth embodiment of this invention.

FIG. 27 is a top view showing the detection subject body and the detectors of FIG. 26.

FIG. 28 is a front view showing the detectors of FIG. 26.

FIG. 29 is a perspective view showing a detection subject body and detectors of an elevator position detection apparatus according to a fourteenth embodiment of this invention.

FIG. 30 is a top view showing the detection subject body and the detectors of FIG. 29.

FIG. 31 is a perspective view showing a detection subject body and detectors of an elevator position detection apparatus according to a fifteenth embodiment of this invention.

FIG. 32 is a perspective view showing a detection subject body and detectors of an elevator position detection apparatus according to a sixteenth embodiment of this invention.

FIG. 33 is a perspective view showing an elevator position detection apparatus according to a seventeenth embodiment of this invention.

### DESCRIPTION OF EMBODIMENTS

Embodiments of this invention will be described below with reference to the drawings.

### First Embodiment

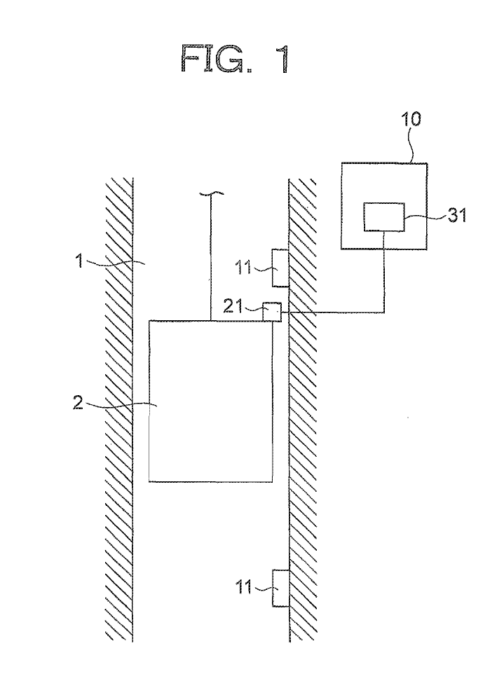

FIG. 1 is a view showing a configuration of an elevator according to a first embodiment of this invention. A car (an elevating body) 2 and a counter weight (not shown) are provided in a hoistway 1. The car 2 and the counter weight are moved through the hoistway 1 in a vertical direction by a driving force of a hoisting machine (a driving apparatus), not shown in the drawing, while being guided individually by a plurality of rails (not shown) disposed in the hoistway 1.

A plurality of detection subject bodies 11 are fixed within the hoistway 1. The detection subject bodies 11 are disposed respectively in a plurality of reference positions set at a remove from each other in a movement direction of the car 2. In this example, positions corresponding to respective floors are set as the reference positions.

A detector 21 that detects the detection subject bodies 11 is provided on top of the car 2. A signal from the detector 21 is transmitted to a control apparatus 10 that controls an operation of the elevator. The control apparatus 10 is provided with a processing unit 31 that specifies a position of the car 2 by processing the signal from the detector 21. The control apparatus 10 controls the operation of the elevator on the basis of the position of the car 2, specified by the processing unit 31. An elevator position detection apparatus includes the plurality of detection subject bodies 11, the detector 21, and the processing unit 31.

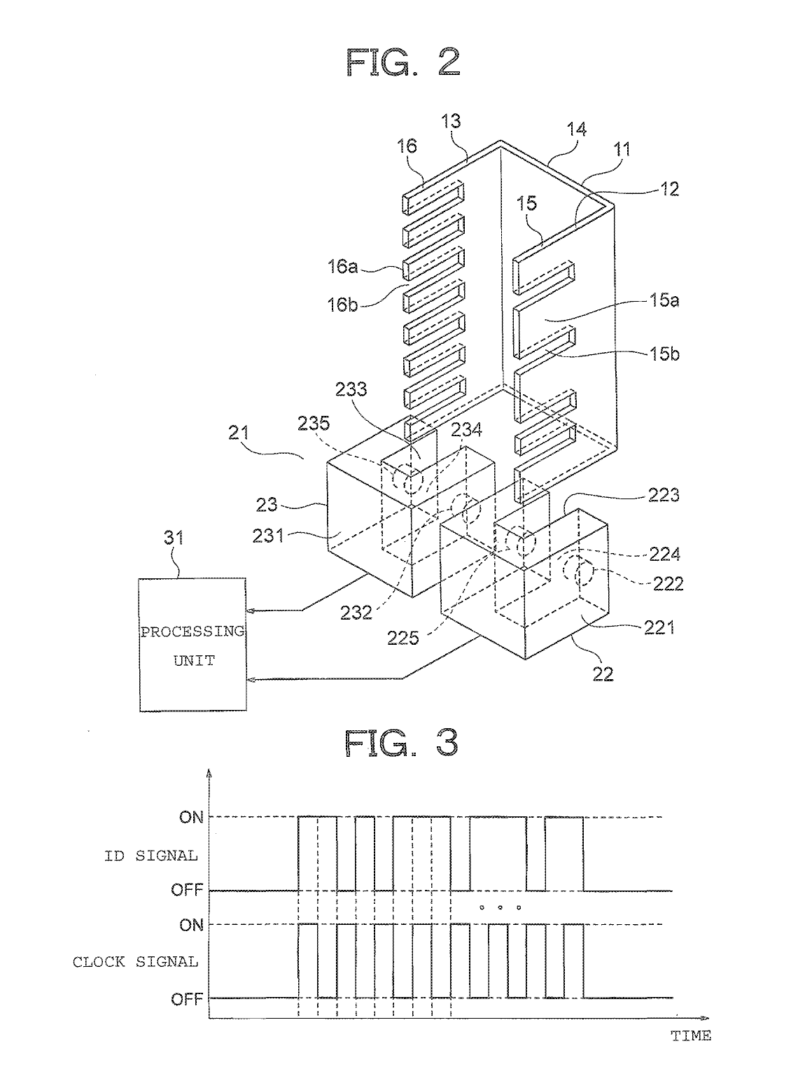

FIG. 2 is a perspective view showing the position detection apparatus of FIG. 1. Each detection subject body 11 includes a first detection subject plate 12 made of metal, a second detection subject plate 13 made of metal, and a connecting portion 14 that connects the first and second detection subject plates 12, 13.

The first and second detection subject plates 12, 13 are integrated via the connecting portion 14 so as to be disposed parallel to each other in the movement direction of the car 2. Further, the first and second detection subject plates 12, 13 are formed at identical dimensions in the movement direction of the car 2. The first and second detection subject plates 12, 13 oppose each other in the horizontal direction such that positions of respective upper end surfaces thereof match each other in the movement direction of the car 2 and positions of respective lower end surfaces thereof match each other in the movement direction of the car 2.

The connecting portion 14 is a plate-shaped member that connects respective horizontal direction end portions of the first and second detection subject plates 12, 13 to each other. In this example, therefore, when the detection subject body 11 is seen from the movement direction of the car 2, the detection subject body 11 is formed substantially in a U shape including the first detection subject plate 12, the second detection subject plate 13, and the connecting portion 14.

The first detection subject plate 12 is provided with an ID sequence (a position information bit sequence) 15 that is formed by arranging a plurality of low resistance portions 15a and a plurality of high resistance portions 15b alternately in the movement direction of the car 2, the low resistance portions 15a serving as first property portions that generate an eddy current in response to an applied magnetic field and the high resistance portions 15b serving as second property portions that are less likely to generate an eddy current than the low resistance portions 15a. In other words, the low resistance portions 15a and the high resistance portions 15b of the first detection subject plate 12 have different properties from each other. The high resistance portions 15b are formed from spaces obtained by removing parts of the first detection subject plate 12. The low resistance portions 15a are formed from parts (plate portions) of the first detection subject plate 12 that remain after forming the spaces. In this example, horizontal slits (spaces) opened in a horizontal direction other end portion of the first detection subject plate 12 are provided in the first detection subject plate 12 as the high resistance portions 15b. Hence, in this example, the first detection subject plate 12 is formed in a comb shape. Electric resistance and magnetic resistance values are higher in the high resistance portions 15b than in the low resistance portions 15a.

In the ID sequence 15, the low resistance portions 15a and the high resistance portions 15b are arranged for each detection subject body 11 in an arrangement pattern that corresponds to the position of the detection subject body 11 within the hoistway 1. The low resistance portions 15a and the high resistance portions 15b of the ID sequence 15 are provided in a different width dimension combination (the width dimension being the dimension in the movement direction of the car 2) for each detection subject body 11 so that the arrangement pattern of the low resistance portions 15a and the high resistance portions 15b corresponds to the position of the detection subject body 11 within the hoistway 1. As a result, the position of the detection subject body 11 within the hoistway 1 can be specified individually from the arrangement pattern of the ID sequence 15. In other words, position information is set in each detection subject body 11 in accordance with the arrangement pattern of the ID sequence 15 in order to specify the position of the detection subject body 11 within the hoistway 1.

The second detection subject plate 13 is provided with a clock sequence (a reading information bit sequence) 16 that is formed by arranging a plurality of low resistance portions 16a and a plurality of high resistance portions 16b alternately in the movement direction of the car 2, the low resistance portions 16a serving as first property portions that generate an eddy current in response to an applied magnetic field and the high resistance portions 16b serving as second property portions that are less likely to generate an eddy current than the low resistance portions 16a. In other words, the low resistance portions 16a and the high resistance portions 16b of the second detection subject plate 13 also have different properties from each other. The high resistance portions 16b are formed from spaces obtained by removing parts of the second detection subject plate 13. The low resistance portions 16a are formed from parts (plate portions) of the second detection subject plate 13 that remain after forming the spaces. In this example, horizontal slits (spaces) opened in a horizontal direction other end portion of the second detection subject plate 13 are provided in the second detection subject plate 13 as the high resistance portions 16b. Hence, in this example, the second detection subject plate 13 is formed in a comb shape. Electric resistance and magnetic resistance values are higher in the high resistance portions 16b than in the low resistance portions 16a.

In the clock sequence 16, the low resistance portions 16a and the high resistance portions 16b are arranged in a predetermined arrangement pattern regardless of the position of the detection subject body 11. The low resistance portions 16a and high resistance portions 16b of the clock sequence 16 are arranged in an identical arrangement pattern in all of the detection subject bodies 11. In this example, the low resistance portions 16a and high resistance portions 16b of the clock sequences 16 of the respective detection subject bodies 11 are all formed to have identical dimensions in the movement direction of the car 2. Reading information is set in each detection subject body 11 in accordance with the arrangement pattern of the clock sequence 16 in order to specify a timing at which the position information set in the ID sequence 15 is read.

The detection subject bodies 11 are disposed in the hoistway 1 such that the positions of all of the ID sequences 15 are aligned in the movement direction of the car 2 and the positions of all of the clock sequences 16 are aligned in the movement direction of the car 2. The first and second detection subject plates 12, 13 are disposed in a common detection subject body 11 so that the arrangement pattern of the ID sequence 15 and the arrangement pattern of the clock sequence 16 correspond to each other in the horizontal direction. In this example, the first and second detection subject plates 12, 13 are disposed such that boundary positions between the low resistance portions 15a and the high resistance portions 15b of the ID sequence 15 are each aligned with a position of one of the boundaries between the low resistance portions 16a and the high resistance portions 16b of the clock sequence 16 in the movement direction of the car 2.

The detector 21 includes an eddy current type first detection unit 22 that detects the position information set in the ID sequence 15 of the first detection subject plate 12, and an eddy current type second detection unit 23 that detects the reading information set in the clock sequence 16 of the second detection subject plate 13. In this example, the first and second detection units 22, 23 are arranged in the horizontal direction.

The first detection unit 22 includes a first support portion (a first housing) 221 fixed to the car 2, and a first magnetic field generating coil 222 and a first magnetic field detecting coil 225 provided respectively in the first support portion 221. A first detection groove 223 is provided in the first support portion 221 so as to extend in the movement direction of the car 2. The ID sequence 15 of each detection subject body 11 is disposed in the first detection groove 223 when seen from the movement direction of the car 2. Hence, when the first detection unit 22 moves together with the car 2 such that the first detection unit 22 passes through the position of the detection subject body 11, the ID sequence 15 of the detection subject body 11 passes through the first detection groove 223.

A first detection region 224 in which a high frequency magnetic field is formed in response to energization of the first magnetic field generating coil 222 is provided in the first detection groove 223. When the first detection subject plate 12 passes through the first detection region 224, an eddy current is generated in the first detection subject plate 12 by the high frequency magnetic field of the first magnetic field generating coil 222. When the ID sequence 15 passes through the first detection region 224, an eddy current is generated only in the low resistance portions 15a made of metal, among the low resistance portions 15a and the high resistance portions 15b, and an eddy current is not generated in the high resistance portions 15b formed as spaces. The first detection unit 22 detects the eddy currents generated by the ID sequence 15 when the ID sequence 15 passes through the first detection region 224 using the first magnetic field detecting coil 225, and outputs a time series signal having different output conditions depending on whether or not an eddy current has been generated (i.e. depending on variation in the eddy current) as an ID signal. In other words, when the ID sequence 15 passes through the first detection region 224, the first detection unit 22 outputs a time series signal having an output condition that switches in accordance with the arrangement pattern of the low resistance portions 15a and the high resistance portions 15b of the ID sequence 15 (i.e. a time series signal having an output condition that switches in the boundary positions between the low resistance portions 15a and the high resistance portions 15b of the ID sequence 15) as the ID signal. In this example, the first detection unit 22 outputs a time series signal that switches ON/OFF in the boundary positions between the low resistance portions 15a and the high resistance portions 15b of the ID sequence 15 as the ID signal. Hence, the ID signal output by the first detection unit 22 differs in relation to each detection subject body 11.

The second detection unit 23 includes a second support portion (a second housing) 231 fixed to the car 2, and a second magnetic field generating coil 232 and a second magnetic field detecting coil 235 provided respectively in the second support portion 231. A second detection groove 233 is provided in the second support portion 231 so as to extend in the movement direction of the car 2. The clock sequence 16 of each detection subject body 11 is disposed in the second detection groove 233 when seen from the movement direction of the car 2. Hence, when the second detection unit 23 moves together with the car 2 such that the second detection unit 23 passes through the position of the detection subject body 11, the clock sequence 16 of the detection subject body 11 passes through the second detection groove 233.

A second detection region 234 in which a high frequency magnetic field is formed in response to energization of the second magnetic field generating coil 232 is provided in the second detection groove 233. A position of the second detection region 234 is identical to a position of the first detection region 224 in the movement direction of the car 2. When the second detection subject plate 13 passes through the second detection region 234, an eddy current is generated in the second detection subject plate 13 by the high frequency magnetic field of the second magnetic field generating coil 232. When the clock sequence 16 passes through the second detection region 234, an eddy current is generated only in the low resistance portions 16a made of metal, among the low resistance portions 16a and the high resistance portions 16b, and an eddy current is not generated in the high resistance portions 16b formed as spaces. The second detection unit 23 detects the eddy currents generated by the clock sequence 16 when the clock sequence 16 passes through the second detection region 234 using the second magnetic field detecting coil 235, and outputs a time series signal having a different output condition depending on whether or not an eddy current has been generated as a clock signal. In other words, when the clock sequence 16 passes through the second detection region 234, the second detection unit 23 outputs a time series signal having an output condition that switches in accordance with the arrangement pattern of the low resistance portions 16a and the high resistance portions 16b of the clock sequence 16 (i.e. a time series signal having an output condition that switches in the boundary positions between the low resistance portions 16a and the high resistance portions 16b of the clock sequence 16) as the clock signal. In this example, the second detection unit 23 outputs a time series signal that switches ON/OFF in the boundary positions between the low resistance portions 16a and the high resistance portions 16b of the clock sequence 16 as the clock signal. Hence, the clock signal output by the second detection unit 23 is identical in each detection subject body 11.

The ID signal output by the first detection unit 22 and the clock signal output by the second detection unit 23 are transmitted to the processing unit 31. The processing unit 31 specifies the position of the car 2 within the hoistway 1 by comparing the ID signal with the clock signal.

FIG. 3 is a graph comparing temporal variation in the respective output conditions of the ID signal and the clock signal output by the first and second detection units 22, 23 of FIG. 2. The processing unit 31 determines the respective output conditions of the ID signal and the clock signal at intervals of a calculation period that is shorter than an ON/OFF switching period of the clock signal. Further, as shown in FIG. 3, the processing unit 31 digitizes the arrangement pattern of the ID sequence 15 by reading the ON/OFF condition (the output condition) of the ID signal in a position where the clock signal switches ON/OFF, and as a result obtains the position information set in the ID sequence 15. Furthermore, the processing unit 31 specifies the position of the car 2 within the hoistway 1 from the position information set in the ID sequence 15.

In this elevator position detection apparatus, the processing unit 31 specifies the position of the car 2 within the hoistway 1 by comparing the ID signal output by the first detection unit 22 with the clock signal output by the second detection unit 23. Accordingly, the output condition of the ID signal can be read using the clock signal as a reference, and therefore a situation in which a reading result of the output condition of the ID signal varies when a speed of the car 2 varies or the like, for example, can be prevented from occurring. Hence, the position information set in the ID sequence 15 of the detection subject body 11 can be read more accurately, and as a result, the position of the car 2 within the hoistway 1 can be specified more accurately. Furthermore, the first and second detection units 22, 23 are eddy current type detection units, and therefore a situation in which the ID sequence 15 and the clock sequence 16 of the detection subject body 11 cannot be detected due to smoke, dust, or the like, for example, can be prevented from occurring. Moreover, even when the detector 21 shifts slightly in the horizontal direction relative to the detection subject body 11, the information included respectively in the ID sequence 15 and the clock sequence 16 is unlikely to be detected erroneously. As a result, the position of the car 2 within the hoistway 1 can be detected more reliably.

Further, the first and second detection subject plates 12, 13 are disposed parallel to each other, and therefore the detection subject body 11 can be manufactured easily. Moreover, the detection subject body 11 can be disposed easily in the hoistway 1.

Furthermore, the first and second detection subject plates 12, 13 are integrated via the connecting portion 14, and therefore fitting errors occurring when the first detection subject plate 12 is fitted to the second detection subject plate 13 can be eliminated. As a result, the position information set in the ID sequence 15 of the detection subject body 11 can be read even more accurately.

Moreover, in the ID sequence 15 and the clock sequence 16, the high resistance portions 15b, 16b are formed from spaces, while the low resistance portions 15a, 16a are formed by the parts (the plate portions) of the first and second detection subject plates 12, 13 that remain after the spaces are formed. Therefore, the high resistance portions 15b, 16b and the low resistance portions 15a, 16a exhibiting different electric resistance values and magnetic resistance values can be formed in the first and second detection subject plates 12, 13 easily.

### Second Embodiment

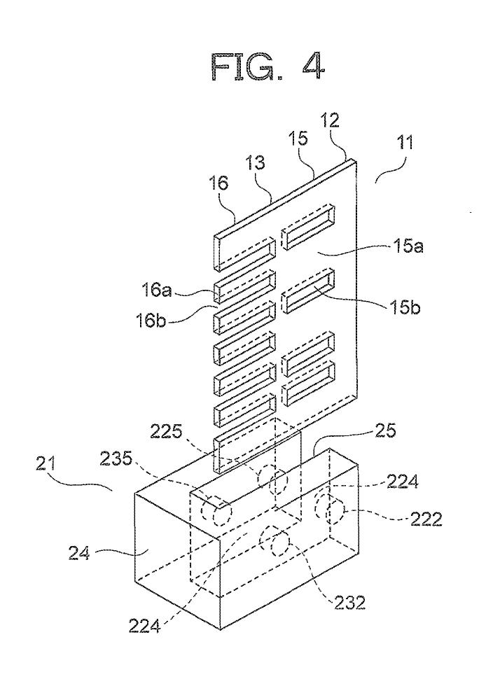

FIG. 4 is a perspective view showing the detection subject body 11 and the detector 21 of an elevator position detection apparatus according to a second embodiment of this invention. In the detection subject body 11, the first detection subject plate 12 and the second detection subject plate 13 are formed integrally on an identical plane extending in the movement direction of the car 2. In this example, the second detection subject plate 13 is disposed in a position that is closer to the car 2 in the horizontal direction than the first detection subject plate 12. Further, in this example, the respective high resistance portions 16b of the clock sequence 16 take the form of horizontal slits opened in an end portion of the second detection subject plate 13, while the respective high resistance portions 15b of the ID sequence 15 take the form of rectangular through-hole portions. The integrated first and second detection subject plates 12, 13 are manufactured by forming a plurality of spaces in a single metal plate so as to provide the ID sequence 15 and the clock sequence 16.

In the detector 21, the first and second support portions 221, 231 are replaced by a common support portion 24, and therefore the first detection unit 22 and the second detection unit 23 are integrated.

A detection groove 25 is provided in the support portion 24 so as to extend in the movement direction of the car 2. The support portion 24 is provided on the car 2 such that a depth direction of the detection groove 25 is aligned with a planar direction of the first and second detection subject plates 12, 13. The ID sequence 15 and the clock sequence 16 are arranged in the depth direction of the detection groove 25. Further, a depth dimension of the detection groove 25 is set such that the ID sequence 15 and the clock sequence 16 can be inserted wholly therein. Hence, when the detector 21 passes the position of the detection subject body 11, the ID sequence 15 and the clock sequence 16 of the detection subject body 11 both pass through the detection groove 25.

The first and second magnetic field generating coils 222, 232 and the first and second magnetic field detecting coils 225, 235 are provided in the common support portion 24. The first detection region 224 in which a high frequency magnetic field is formed in response to energization of the first magnetic field generating coil 222 and the second detection region 234 in which a high frequency magnetic field is formed in response to energization of the second magnetic field generating coil 232 are provided in the detection groove 25. The first detection region 224 and the second detection region 234 are arranged horizontally in the depth direction of the detection groove 25. When the detector 21 passes the position of the detection subject body 11, the ID sequence 15 passes through the first detection region 224 and the clock sequence 16 passes through the second detection region 234. All other configurations are identical to the first embodiment.

By forming the first detection subject plate 12 and the second detection subject plate 13 integrally on an identical plane extending in the movement direction of the car 2 in this manner, fitting errors occurring when the first detection subject plate 12 is fitted to the second detection subject plate 13 can be eliminated. As a result, the position information set in the ID sequence 15 of the detection subject body 11 can be read even more accurately. Further, the first and second detection subject plates 12, 13 can be formed integrally from a single metal plate without bending the metal plate, and as a result, the first and second detection subject plates 12, 13 can be manufactured easily.

Furthermore, since the first and second detection units 22, 23 are formed integrally, the detector 21 can be manufactured easily. Moreover, fitting errors occurring when the first detection unit 22 is fitted to the second detection unit 23 can be eliminated, and as a result, the position information set in the ID sequence 15 can be read even more accurately.

Note that in the example described above, the second detection subject plate 13 is disposed in a position that is closer to the car 2 in the horizontal direction than the first detection subject plate 12, but instead, the first detection subject plate 12 may be disposed in a position that is closer to the car 2 in the horizontal direction than the second detection subject plate 13.

### Third Embodiment

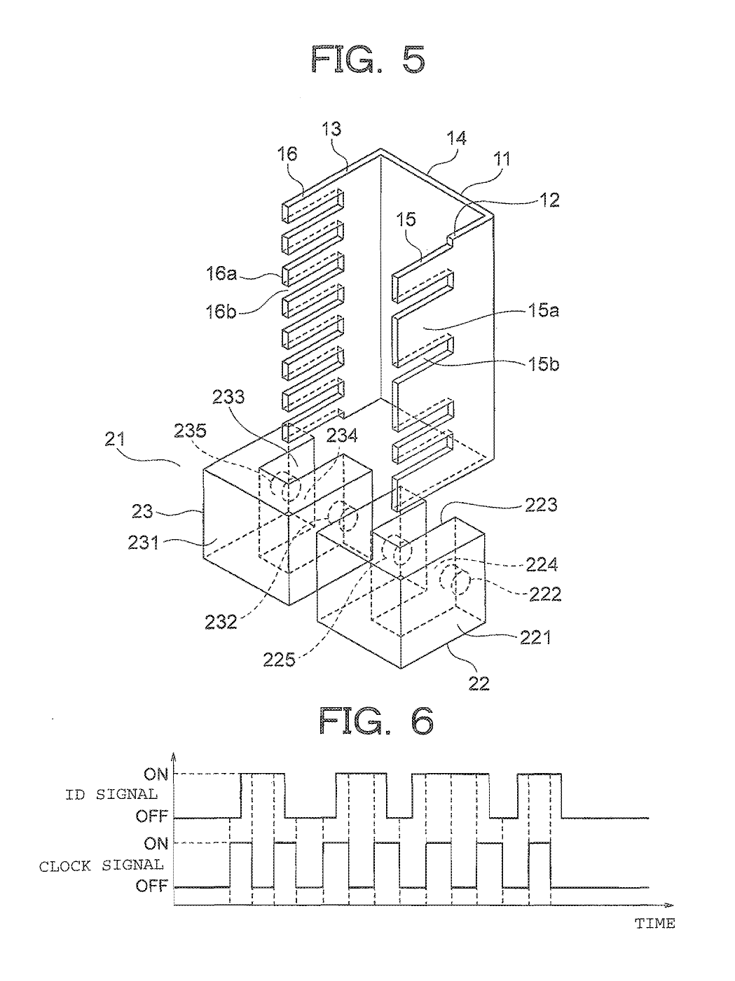

FIG. 5 is a perspective view showing the detection subject body 11 and the detector 21 of an elevator position detection apparatus according to a third embodiment of this invention. Further, FIG. 6 is a graph comparing temporal variation in the respective conditions of the ID signal and the clock signal output by the first and second detection units 22, 23 of FIG. 5. In a common detection subject body 11, the boundary positions between the low resistance portions 15a and the high resistance portions 15b of the ID sequence 15 are offset from the boundary positions between the low resistance portions 16a and the high resistance portions 16b of the clock sequence 16 in the movement direction of the car 2. In this example, when a width dimension of the low resistance portions 16a and the high resistance portions 16b of the clock sequence 16 is set as a reference dimension, the ID sequence 15 is disposed at an offset of ½ the reference dimension from the clock sequence 16 in the movement direction of the car 2. In this example, therefore, as shown in FIG. 6, when a time extending from a point at which the clock signal switches ON to a point at which the clock signal next switches OFF (or a time extending from a point at which the clock signal switches OFF to a point at which the clock signal next switches ON) is set as the ON/OFF switching period (a single period) of the clock signal, a timing at which the ON/OFF condition (the output condition) of the ID signal generated by the first detection unit 22 switches is offset from a timing at which the ON/OFF condition (the output condition) of the clock signal generated by the second detection unit 23 switches by a period corresponding to ½ the ON/OFF switching period of the clock signal. All other configurations are identical to the first embodiment.

In this elevator position detection apparatus, in the common detection subject body 11, the boundary positions between the low resistance portions 15a and the high resistance portions 15b of the ID sequence 15 are offset from the boundary positions between the low resistance portions 16a and the high resistance portions 16b of the clock sequence 16 in the movement direction of the car 2, and therefore the timing at which the ID signal switches ON/OFF can be offset from the timing at which the clock signal switches ON/OFF. Accordingly, the need to align respective ON/OFF switching positions of the ID signal and the clock signal can be eliminated, and as a result, detection errors by the detector 21 due to a manufacturing error in the detection subject body 11 or the like can be suppressed. More specifically, when an attempt is made to align the respective ON/OFF switching positions of the ID signal and the clock signal, the condition of the ID signal read by the processing unit 31 is highly likely to vary if the ON/OFF switching positions of the clock signal deviate from the ON/OFF switching positions of the ID signal even slightly due to a manufacturing error in the detection subject body 11 or the like. When the ON/OFF switching positions of the ID signal and the clock signal are offset in advance, however, the condition of the ID signal read by the processing unit 31 is unlikely to vary even in a case where the ON/OFF switching positions of the clock signal deviate slightly from the ON/OFF switching positions of the ID signal. As a result, detection errors by the detector 21 due to a manufacturing error in the detection subject body 11 or the like can be suppressed.

### Fourth Embodiment

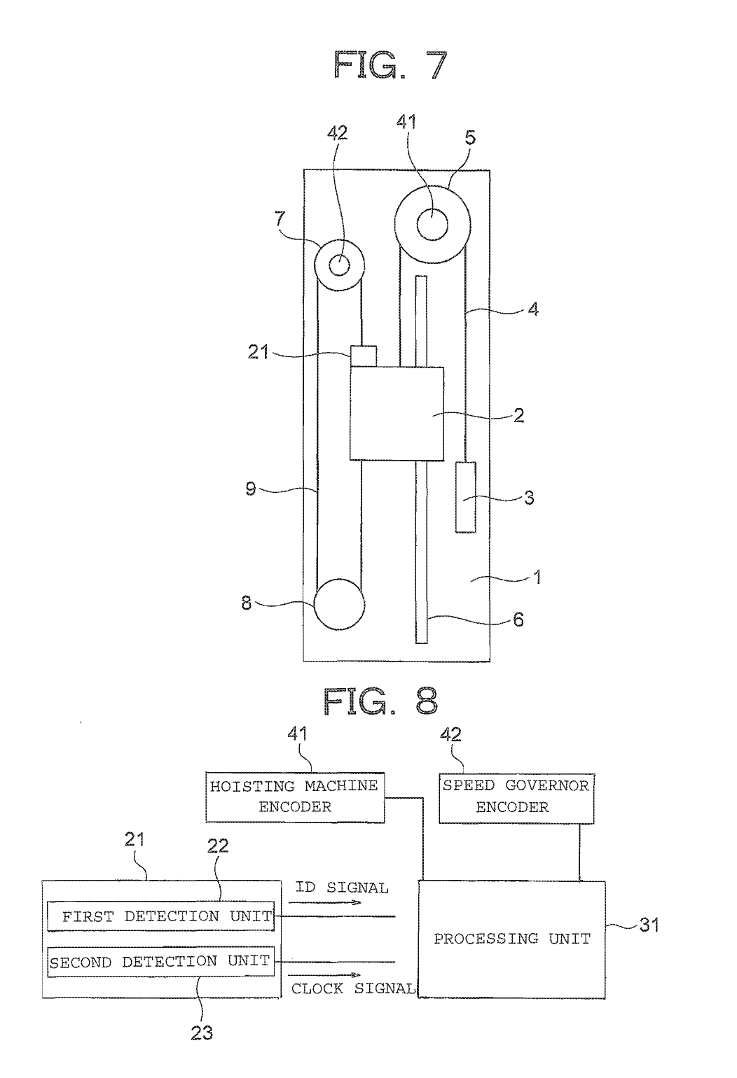

FIG. 7 is a view showing a configuration of an elevator according to a fourth embodiment of this invention. In the drawing, the car 2 and a counter weight 3 provided in the hoistway 1 are suspended from a main cable (a rope, a belt, or the like, for example) 4. The main cable 4 is wound around a drive sheave of a hoisting machine (the driving apparatus) 5 provided in an upper portion of the hoistway 1. The car 2 and the counter weight 3 are moved through the hoistway 1 in the vertical direction by a driving force from the hoisting machine 5 while being guided individually by a plurality of rails 6. The car 2 and the counter weight 3 are moved in accordance with rotation of the drive sheave of the hoisting machine 5.

A safety device (not shown) that forcibly applies a braking force to the car 2 by gripping the rails 6 when the speed of the car 2 becomes abnormal is provided on the car 2. A speed governor 7 is provided in the upper portion of the hoistway 1, and a tension pulley 8 is provided in a lower portion of the hoistway 1. A speed governor rope 9 wound in a loop between a speed governor sheave of the speed governor 7 and the tension pulley 8 is connected to an operating lever of the safety device. Hence, the speed governor sheave of the speed governor 7 and the tension pulley 8 rotate in accordance with the movement of the car 2. When the speed of the car 2 increases such that a rotation speed of the speed governor sheave becomes abnormal, the speed governor 7 grips the speed governor rope 9, whereby the operating lever of the safety device is operated. When the operating lever of the safety device is operated, the safety device grips the rails 6.

The hoisting machine 5 is provided with a hoisting machine encoder (a hoisting machine rotation detector) 41 that generates a signal (a pulse signal) corresponding to the rotation of the drive sheave. The speed governor 7 is provided with a speed governor encoder (a speed governor rotation detector) 42 that generates a signal (a pulse signal) corresponding to the rotation of the speed governor sheave. Hence, the hoisting machine encoder 41 and the speed governor encoder 42 both generate signals corresponding to the movement of the car 2.

FIG. 8 is a block diagram showing the elevator position detection apparatus of FIG. 7. The respective signals from the hoisting machine encoder 41 and the speed governor encoder 42 are transmitted to the processing unit 31. The processing unit 31 determines the movement direction of the car 2 on the basis of the respective signals from the hoisting machine encoder 41 and the speed governor encoder 42. Further, the processing unit 31 specifies the position of the car 2 within the hoistway 1 on the basis of information indicating the determined movement direction of the car 2, the ID signal from the first detection unit 22, and the clock signal from the second detection unit 23. In other words, the processing unit 31 specifies the position of the car 2 within the hoistway 1 by reading the ID signal using the clock signal as a reference while comparing the clock signal and the ID signal in the movement direction of the car 2. All other configurations are identical to the first embodiment.

In this elevator position detection apparatus, the processing unit 31 determines the movement direction of the car 2 on the basis of the respective signals from the hoisting machine encoder 41 and the speed governor encoder 42, and can therefore perform processing after aligning the clock signal and the ID signal in the movement direction of the car 2. Hence, the arrangement pattern of the ID sequence 15 does not have to be vertically symmetrical, and as a result, the arrangement pattern of the ID sequence 15 can be selected with a greater degree of freedom.

Note that in the example described above, the processing unit 31 determines the movement direction of the car 2 on the basis of the respective signals from the hoisting machine encoder 41 and the speed governor encoder 42, but the processing unit 31 may determine the movement direction of the car 2 on the basis of only one of the respective signals from the hoisting machine encoder 41 and the speed governor encoder 42.

### Fifth Embodiment

FIG. 9 is a view showing a configuration of the detection subject body 11 of an elevator position detection apparatus according to a fifth embodiment of this invention. In the detection subject body 11, similarly to the second embodiment, the first and second detection subject plates 12, 13 are formed integrally on an identical plane extending in the movement direction of the car 2. In this example, the high resistance portions 15b of the ID sequence 15 and the high resistance portions 16b of the clock sequence 16 are all constituted by rectangular through-hole portions. In other words, in this example, the first and second detection subject plates 12, 13 are formed integrally from a single perforated plate. The integrated first and second detection subject plates 12, 13 are manufactured by forming a plurality of spaces in a single metal plate so as to provide the ID sequence 15 and the clock sequence 16. All other configurations are identical to the second embodiment.

By forming the first and second detection subject plates 12, 13 integrally from a single perforated plate in this manner, the detection subject body 11 can be manufactured easily. Moreover, the detection subject body 11 can be strengthened in comparison with a comb-shaped plate.

### Sixth Embodiment

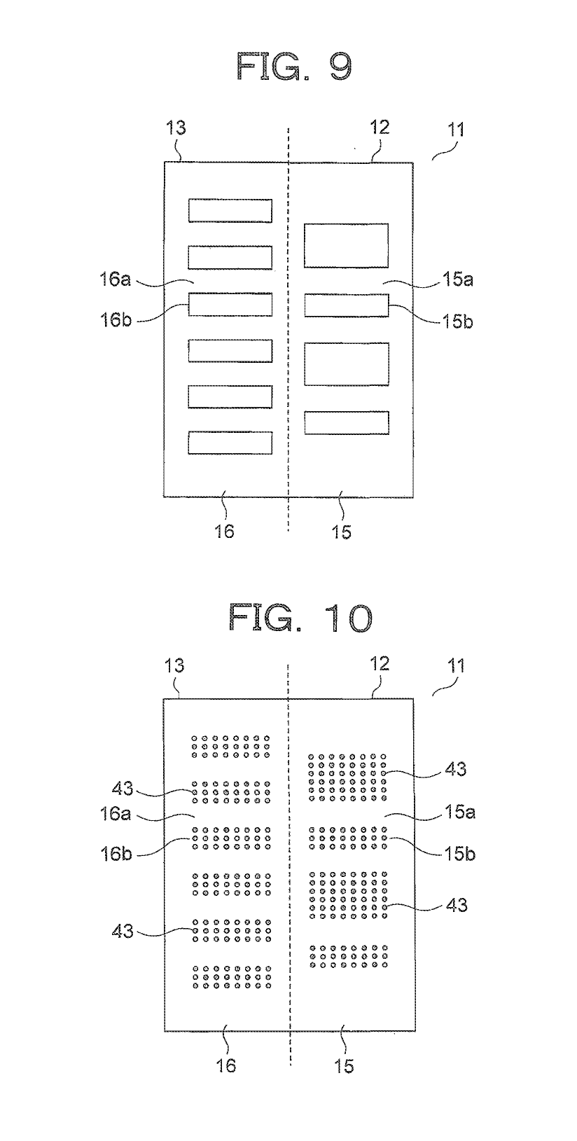

FIG. 10 is a view showing a configuration of the detection subject body 11 of an elevator position detection apparatus according to a sixth embodiment of this invention. A plurality of punch holes (spaces) 43 are formed separately in each of the high resistance portions 15b, 16b of the ID sequence 15 and the clock sequence 16. As a result, the parts of the first detection subject plate 12 corresponding to the respective high resistance portions 15b are formed in mesh form, and the parts of the second detection subject plate 13 corresponding to the respective high resistance portions 16b are formed in mesh form. Overall, the high resistance portions 15b, 16b have higher electrical resistance and magnetic resistance values than the low resistance portions 15a, 16a. Therefore, in the ID sequence 15 and the clock sequence 16, eddy currents are less likely to be generated in the high resistance portions 15b, 16b than in the low resistance portions 15a, 16a. When the ID sequence 15 passes through the first detection region 224, an amount of eddy current generated by the high resistance portions 15b is smaller than an amount of eddy current generated by the low resistance portions 15a, and when the clock sequence 16 passes through the second detection region 234, an amount of eddy current generated by the high resistance portions 16b is smaller than an amount of eddy current generated by the low resistance portions 16a.

The first detection unit 22 detects variation in the amount of eddy current generated by the ID sequence 15 when the ID sequence 15 passes through the first detection region 224, and outputs a time series signal corresponding to the variation in the eddy current as the ID signal. In other words, when the ID sequence 15 passes through the first detection region 224, the first detection unit 22 outputs a time series signal that switches condition in accordance with the arrangement pattern of the low resistance portions 15a and the high resistance portions 15b of the ID sequence 15 (i.e. a time series signal that switches condition in the boundary positions between the low resistance portions 15a and the high resistance portions 15b of the ID sequence 15) as the ID signal.

The second detection unit 23 detects variation in the amount of eddy current generated by the clock sequence 16 when the clock sequence 16 passes through the second detection region 234, and outputs a time series signal having a different output condition according to the variation in the eddy current as the clock signal. In other words, when the clock sequence 16 passes through the second detection region 234, the second detection unit 23 outputs a time series signal having an output condition that switches in accordance with the arrangement pattern of the low resistance portions 16a and the high resistance portions 16b of the clock sequence 16 (i.e. a time series signal having an output condition that switches in the boundary positions between the low resistance portions 16a and the high resistance portions 16b of the clock sequence 16) as the clock signal. All other configurations are identical to the fifth embodiment.

By forming the plurality of punch holes 43 in the respective high resistance portions 15b, 16b in this manner, the detection subject body 11 can be manufactured more easily, and the detection subject body 11 can be strengthened even further.

### Seventh Embodiment

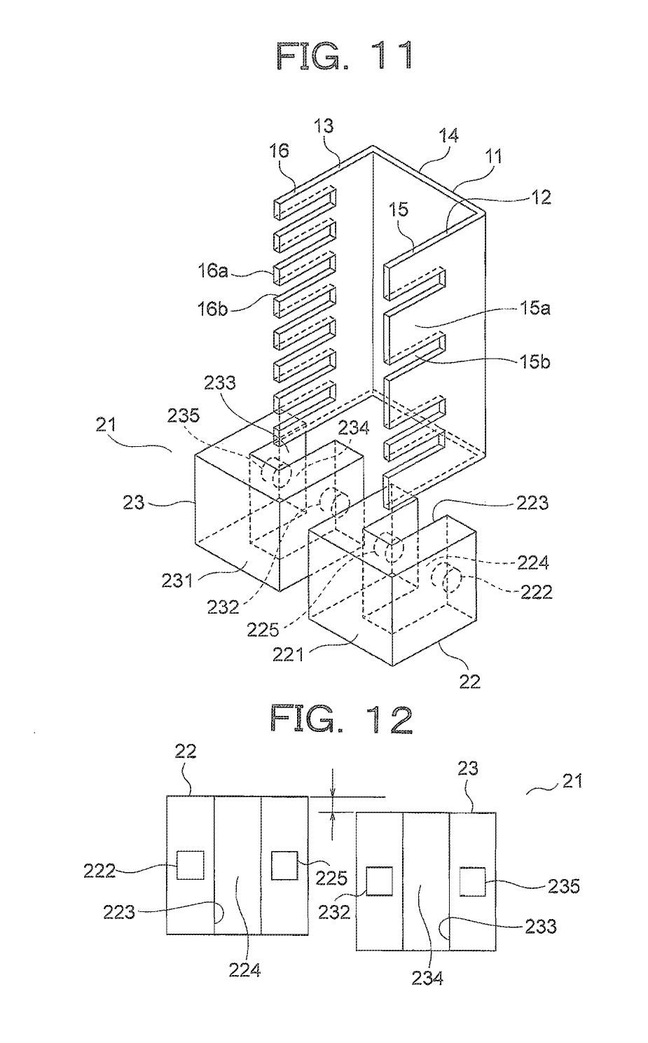

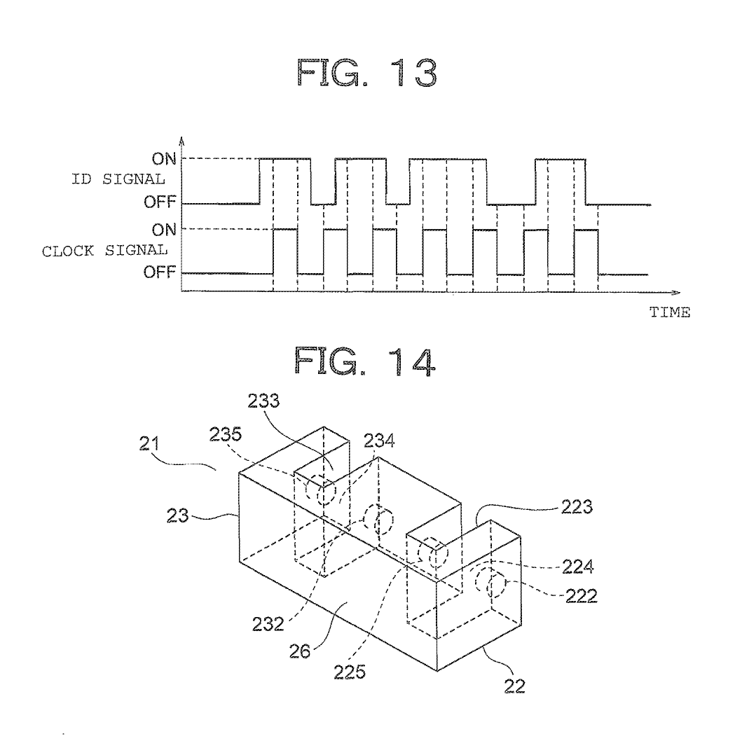

FIG. 11 is a perspective view showing the detection subject body 11 and the detector 21 of an elevator position detection apparatus according to a seventh embodiment of this invention. Further, FIG. 12 is a side view showing the detector 21 of FIG. 11, and FIG. 13 is a graph comparing temporal variation in the respective conditions of the ID signal and the clock signal output by the first and second detection units 22, 23 of FIG. 11. The first and second detection units 22, 23 are disposed in the detector 21 so as to be offset from each other in the movement direction of the car 2. As a result, the position of the first detection region 224 provided in the first detection unit 22 and the position of the second detection region 234 provided in the second detection unit 23 are offset from each other in the movement direction of the car 2. In this example, as shown in FIG. 12, when the width dimension of the low resistance portions 16a and the high resistance portions 16b of the clock sequence 16 is set as the reference dimension, the position of the first detection region 224 and the position of the second detection region 234 are offset from each other by a dimension corresponding to ½ the reference dimension in the movement direction of the car 2. In this example, therefore, as shown in FIG. 13, the timing at which the ON/OFF condition (the output condition) of the ID signal generated by the first detection unit 22 switches is offset from the timing at which the ON/OFF condition (the output condition) of the clock signal generated by the second detection unit 23 switches by a period corresponding to ½ the ON/OFF switching period of the clock signal. All other configurations are identical to the first embodiment.

In this elevator position detection apparatus, the position of the first detection region 224 is offset from the position of the second detection region 234 in the movement direction of the car 2, and therefore, similarly to the third embodiment, the timing at which the ID signal switches ON/OFF can be offset from the timing at which the clock signal switches ON/OFF. As a result, detection errors by the detector 21 due to a fitting error in the detector 21, a manufacturing error in the detection subject body 11, or the like, for example, can be suppressed.

### Eighth Embodiment

FIG. 14 is a perspective view showing the detector 21 of an elevator position detection apparatus according to an eighth embodiment of this invention. In the detector 21, the first and second support portions 221, 231 are replaced by a common support portion 26. As a result, the first detection unit 22 and the second detection unit 23 are integrated.

The first detection groove 223 and the second detection groove 233 are provided separately in the common support portion 26 in alignment with an interval between the first detection subject plate 12 and the second detection subject plate 13. The first magnetic field generating coil 222 that forms a high frequency magnetic field in the first detection region 224 provided in the first detection groove 223, the first magnetic field detecting coil 225 that detects the magnetic field from the eddy currents generated by the ID sequence 15, the second magnetic field generating coil 232 that forms a high frequency magnetic field in the second detection region 234 provided in the second detection groove 233, and the second magnetic field detecting coil 235 that detects the magnetic field from the eddy currents generated by the clock sequence 16 are also provided in the common support portion 26. All other configurations are identical to the first embodiment.

By forming the first and second support portions 221, 231 integrally so that the first and second detection units 22, 23 are integrated while keeping the first and second detection grooves 223, 233 separate in this manner, reductions can be achieved in the size and the number of components of the detector 21.

### Ninth Embodiment

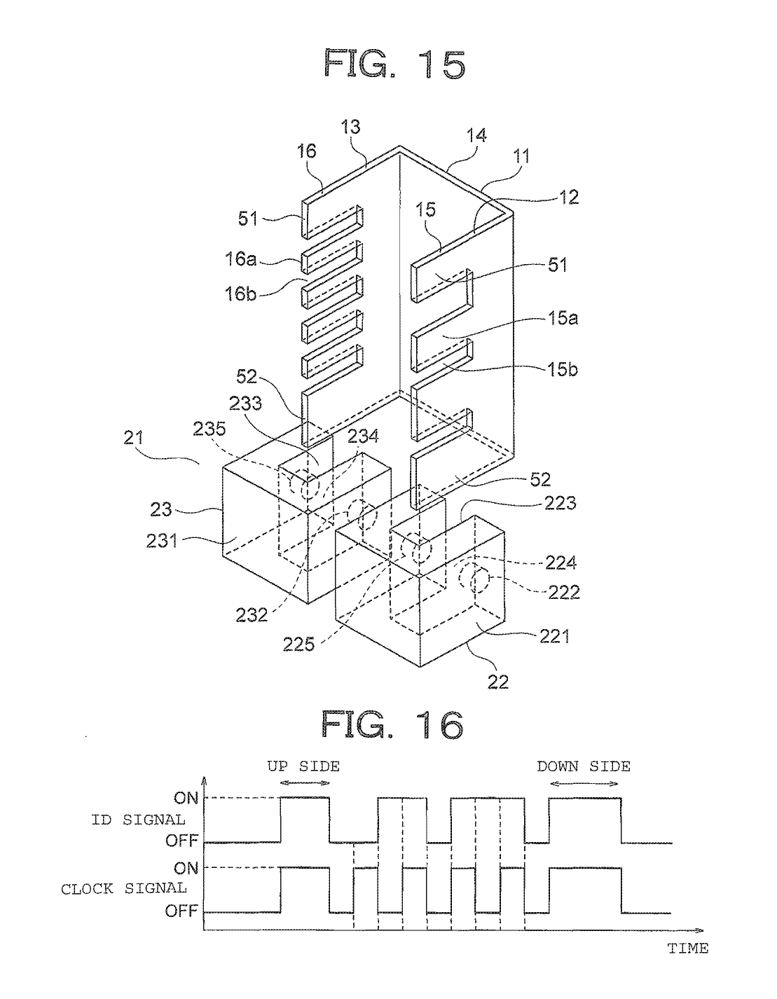

FIG. 15 is a perspective view showing the detection subject body 11 and the detector 21 of an elevator position detection apparatus according to a ninth embodiment of this invention, and FIG. 16 is a graph comparing temporal variation in the respective conditions of the ID signal and the clock signal output by the first and second detection units 22, 23 of FIG. 15. Upper end identification portions (UP side unique bits) 51 are provided on respective upper end portions of the ID sequence 15 and the clock sequence 16, and lower end identification portions (DOWN side unique bits) 52 are provided on respective lower end portions of the ID sequence 15 and the clock sequence 16. The upper end identification portion 51 and the lower end identification portion 52 of the ID sequence 15 are constituted by the low resistance portions 15a of the ID sequence 15, while the upper end identification portion 51 and the lower end identification portion 52 of the clock sequence 16 are constituted by the low resistance portions 16a of the clock sequence 16.

As shown in FIG. 16, information indicating dimensions of the respective upper end identification portions 51 (information corresponding to the upper end identification portions 51) and information indicating dimensions of the respective lower end identification portions 52 (information corresponding to the lower end identification portions 52) are included in the ID signal generated by the first detection unit 22 and the clock signal generated by the second detection unit 23, respectively, as upper end identification information and lower end identification information.

The dimensions of the respective upper end identification portions 51 of the ID sequence 15 and the clock sequence 16 are identical to each other in the movement direction of the car 2, and the dimensions of the respective lower end identification portions 52 of the ID sequence 15 and the clock sequence 16 are identical to each other in the movement direction of the car 2. Accordingly, the output conditions of the ID signal and the clock signal corresponding to the respective upper end identification portions 51 switch at an identical timing, and the output conditions of the ID signal and the clock signal corresponding to the respective lower end identification portions 52 switch at an identical timing.

Further, when the upper end identification portion 51 is compared with the lower end identification portion 52, the upper end identification portion 51 and the lower end identification portion 52 have different dimensions in the movement direction of the car 2. In other words, the upper end identification portion 51 and the lower end identification portion 52 are differentiated from each other by a difference in the dimensions thereof in the movement direction of the car 2, and therefore different upper end identification information and lower end identification information are included respectively in the ID signal and the clock signal. In this example, the dimension of the upper end identification portion 51 in the movement direction of the car 2 is smaller than the dimension of the lower end identification portion 52 in the movement direction of the car 2.

The processing unit 31 determines the movement direction of the car 2 on the basis of the upper end identification information and the lower end identification information (the information corresponding to the upper end identification portions 51 and the lower end identification portions 52) included respectively in the ID signal and the clock signal output from the first and second detection units 22, 23. More specifically, the processing unit 31 distinguishes the upper end identification information included in the ID signal from the lower end identification information included in the clock signal by a difference in the duration of the output condition of the respective signals, and determines the movement direction of the car 2 from an order in which the upper end identification information the lower end identification information are output.

Further, the processing unit 31 specifies the position of the car 2 within the hoistway 1 on the basis of information indicating the determined movement direction of the car 2, the ID signal from the first detection unit 22, and the clock signal from the second detection unit 23. In other words, the processing unit 31 specifies the position of the car 2 within the hoistway 1 by reading the ID signal using the clock signal as a reference while comparing the clock signal and the ID signal in the movement direction of the car 2. All other configurations are identical to the first embodiment.

By thus providing the upper end identification portions 51 on the respective upper end portions of the ID sequence 15 and the clock sequence 16, providing the lower end identification portions 52 on the respective lower end portions of the ID sequence 15 and the clock sequence 16, and making the upper end identification information corresponding to the upper end identification portions 51 and the lower end identification information corresponding to the lower end identification portions 52 different from each other, the movement direction of the car 2 can be determined on the basis of the order in which the upper end identification information and the lower end identification information included respectively in the ID signal and the clock signal are output. Hence, the movement direction of the car 2 can be specified easily from the ID signal and the clock signal alone, without using a hoisting machine encoder and a speed governor encoder, as in the fourth embodiment, for example. As a result, structural complexity in the elevator position detection apparatus can be avoided.

Note that in the example described above, the dimension of the upper end identification portion 51 is smaller than the dimension of the lower end identification portion 52 in the movement direction of the car 2, but instead, the dimension of the upper end identification portion 51 may be larger than the dimension of the lower end identification portion 52 in the movement direction of the car 2.

Further, in the example described above, the upper end identification portion 51 and the lower end identification portion 52 are differentiated from each other by the difference in the respective dimensions thereof in the movement direction of the car 2, but instead, the upper end identification portion 51 and the lower end identification portion 52 may be differentiated from each other by forming the upper end identification portion 51 and the lower end identification portion 52 of the ID sequence 15 respectively from unique bit sequences obtained by arranging the low resistance portions 15a and the high resistance portions 15b, forming the upper end identification portion 51 and the lower end identification portion 52 of the clock sequence 16 respectively from unique bit sequences obtained by arranging the low resistance portions 16a and the high resistance portions 16b, and making the arrangement patterns of the bit sequences forming the upper end identification portions 51 different from the arrangement patterns of the bit sequences forming the lower end identification portions 52.

### Tenth Embodiment

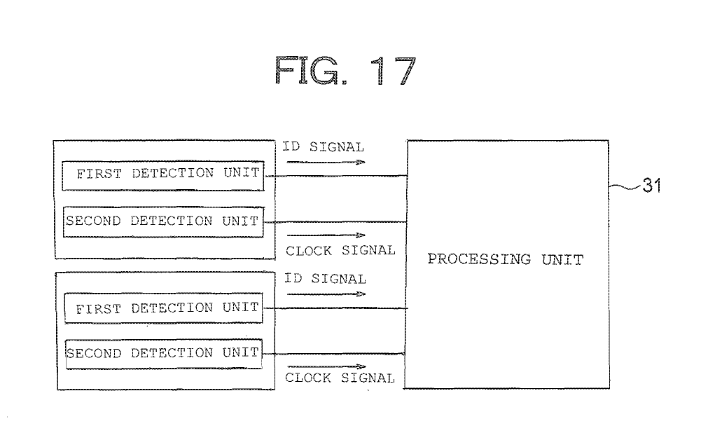

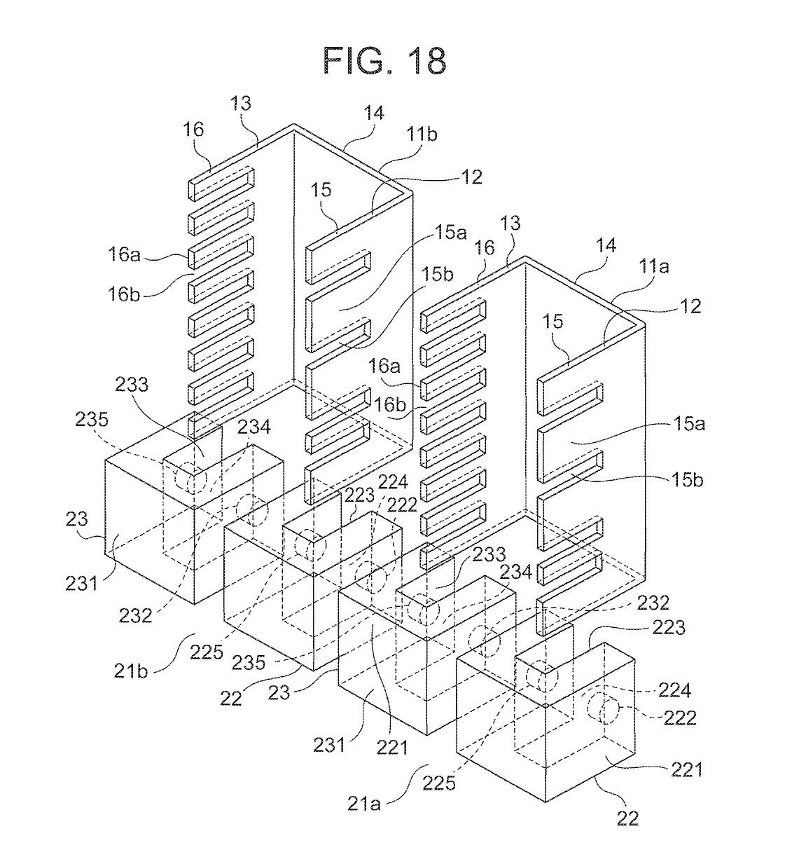

FIG. 17 is a block diagram showing an elevator position detection apparatus according to a tenth embodiment of this invention, and FIG. 18 is a perspective view showing detection subject bodies 11a, 11b and detectors 21a, 21b of the elevator position detection apparatus of FIG. 17. A plurality of detection subject bodies are fixed in each reference position in the movement direction of the car 2. In this example, two detection subject bodies 11a, 11b are fixed in each reference position. The detection subject bodies 11a, 11b fixed in a common reference position are arranged in the horizontal direction. Further, identical position information and identical reading information are set respectively in the ID sequences 15 and the clock sequences 16 of the detection subject bodies 11a, 11b fixed in the common reference position. The detection subject bodies 11a, 11b are configured identically to the detection subject body 11 according to the first embodiment.

The detectors 21a, 21b are provided in the car 2 in an identical number to the detection subject bodies 11a, 11b disposed in the common reference position. In this example, the detector 21a and the detector 21b are provided in the car 2 in an A system corresponding to the detection subject body 11a and a B system corresponding to the detection subject body 11b, respectively. The detectors 21a, 21b are arranged in the horizontal direction in alignment with the respective positions of the detection subject bodies 11a, 11b disposed in the common reference position. The detectors 21a, 21b detect the corresponding detection subject bodies 11a, 11b individually when the car 2 moves so that the respective detectors 21a, 21b pass through the reference position. Similarly to the first embodiment, when the detectors 21a, 21b detect the detection subject bodies 11a, 11b, ID signals are output respectively from the first detection units 22 and clock signals are output respectively from the second detection units 23. The detectors 21a, 21b are configured identically to the detector 21 according to the first embodiment.

The plurality of (in this example, the two) ID signals output respectively from the first detection units 22 and the plurality of (in this example, the two) clock signals output respectively from the second detection units 23 are transmitted to the processing unit 31. The processing unit 31 determines whether or not an abnormality has occurred in the elevator on the basis of the information received from the respective detectors 21a, 21b. In other words, the processing unit 31 determines whether or not an abnormality has occurred in the elevator by comparing the respective ID signals to each other and comparing the respective clock signals to each other. More specifically, the processing unit 31 determines that an abnormality has not occurred when no inconsistencies are found between the respective ID signals and the respective clock signals, and determines that an abnormality has occurred when an inconsistency is found between the respective ID signals or between the respective clock signals. Further, after determining that an abnormality has not occurred, the processing unit 31 specifies the position of the car 2 within the hoistway 1 on the basis of the ID signals and the clock signals in a similar manner to the first embodiment. In other words, redundancy is provided in the processing for specifying the position of the car 2.

The control apparatus 10 controls the operation of the elevator on the basis of the determination made by the processing unit 31 as to whether or not an abnormality has occurred in the elevator. In this example, when the processing unit 31 determines that an abnormality has occurred, the control apparatus 10 performs control to stop the car 2 at the nearest floor and then halt the service operation of the elevator. All other configurations are identical to the first embodiment.

In this elevator position detection apparatus, the processing unit 31 determines whether or not an abnormality has occurred in the elevator by comparing the respective ID signals from the plurality of detectors 21a, 21b and comparing the respective clock signals from the plurality of detectors 21a, 21b, and therefore an abnormality caused by a fault in the position detection apparatus or the like can be detected, enabling an improvement in the safety of the elevator.

### Eleventh Embodiment

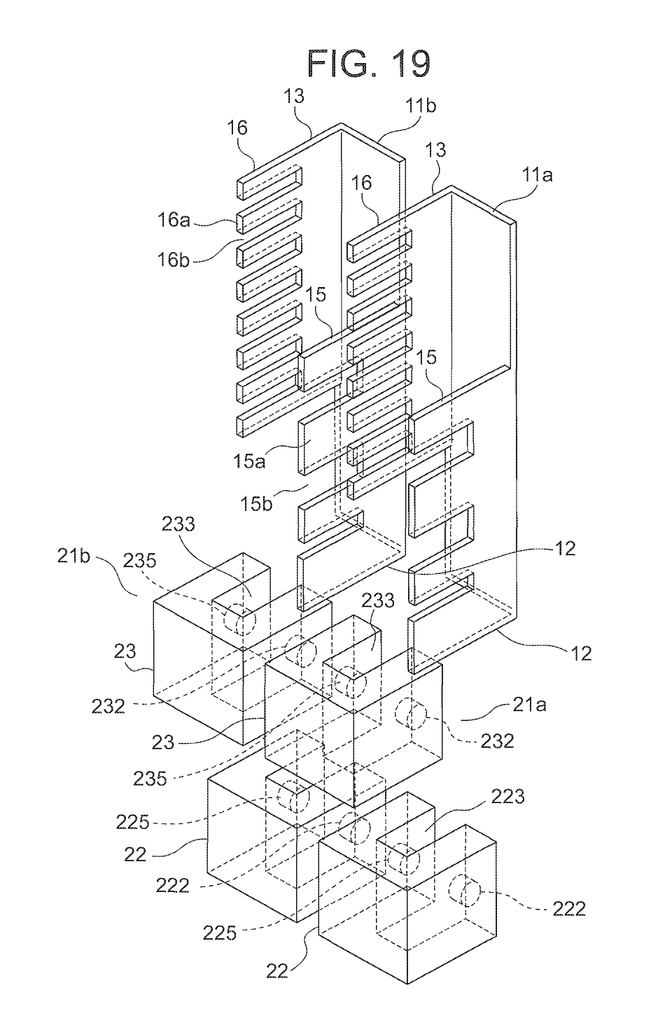

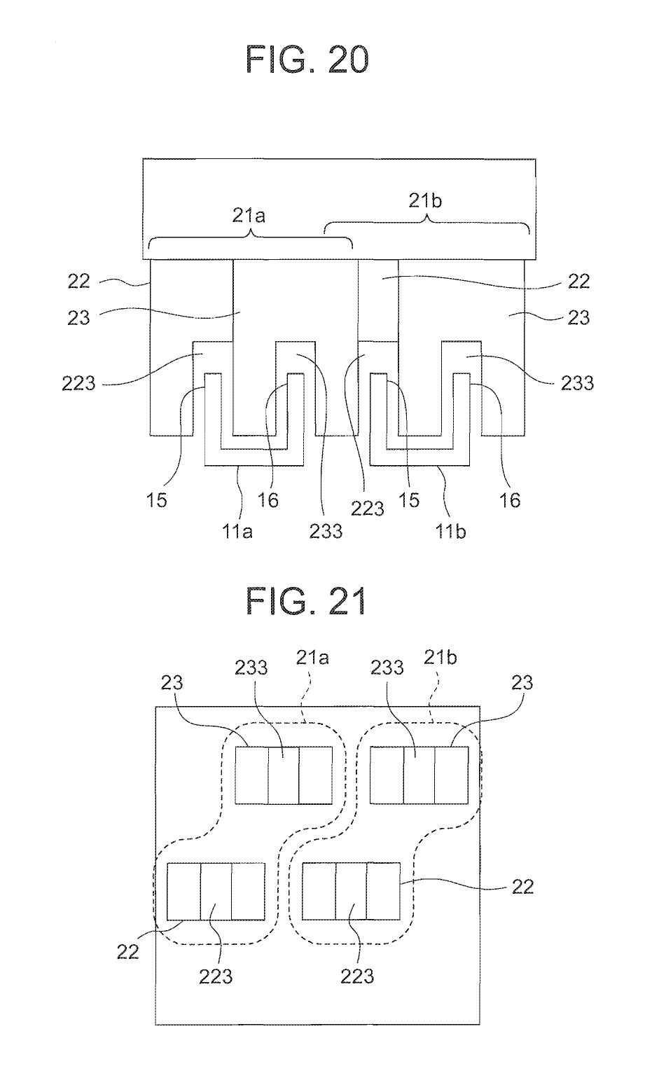

FIG. 19 is a perspective view showing the detection subject bodies 11a, 11b and the detectors 21a, 21b of an elevator position detection apparatus according to an eleventh embodiment of this invention. Further, FIG. 20 is a top view showing the detection subject bodies 11a, 11b and the detectors 21a, 21b of FIG. 19, and FIG. 21 is a front view showing the detectors 21a, 21b of FIG. 20. In the A system and B system detectors 21a, 21b provided in the car 2, as shown in FIG. 21, the first detection units 22 and the second detection units 23 are disposed at a remove from each other in the movement direction of the car 2. Further, when the detectors 21a, 21b are seen from above, as shown in FIG. 20, the first detection units 22 and the second detection units 23 are disposed so as to deviate from each other in the horizontal direction, with the result that the respective first detection units 22 partially overlap the respective second detection units 23. Furthermore, as well as the partial overlap between the first and second detection units 22, 23 of the respective detectors 21a, 21b, when the detectors 21a, 21b are seen from above, the second detection unit 23 of the A system detector 21a partially overlaps the first detection unit 22 of the B system detector 21b. Moreover, when the detectors 21a, 21b are seen from above, the first detection units 22 are disposed so as to avoid the second detection grooves 233, and the second detection units 23 are disposed as to avoid the first detection grooves 223.

In this example, the first detection unit 22 and the second detection unit 23 of the A system detector 21a are disposed at different heights from each other, while the first detection unit 22 and the second detection unit 23 of the B system detector 21b are disposed at different heights from each other and in alignment with the respective heights of the first detection unit 22 and the second detection unit 23 of the A system detector 21a. Further, in this example, when the detectors 21a, 21b are seen from above, the respective first detection units 22 and the respective second detection units 23 are arranged so that the first and second detection grooves 223, 233 are respectively aligned in the width direction. All other configurations of the detectors 21a, 21b are identical to the configurations of the detectors 21a, 21b according to the tenth embodiment.

The plurality of (in this example, the two) detection subject bodies 11a, 11b fixed to the common reference position are arranged in the horizontal direction. Further, identical position information and identical reading information are set respectively in the ID sequences 15 and the clock sequences 16 of the detection subject bodies 11a, 11b fixed in the common reference position. Furthermore, when the detection subject bodies 11a, 11b are seen from above, as shown in FIG. 20, the ID sequence 15 and the clock sequence 16 of the detection subject body 11a are inserted respectively into the first detection groove 223 and the second detection groove 233 of the A system detector 21a, while the ID sequence 15 and the clock sequence 16 of the detection subject body 11b are inserted respectively into the first detection groove 223 and the second detection groove 233 of the B system detector 21b. Hence, when the car 2 moves so that the respective detectors 21a, 21b pass through the reference position, the ID sequences 15 of the respective detection subject bodies 11a, 11b pass through the first detection grooves 223 of the respective first detection units 22, while the clock sequences 16 of the respective detection subject bodies 11a, 11b pass through the second detection grooves 233 of the respective second detection units 23.

Further, in the respective detection subject bodies 11a, 11b fixed to the common reference position, the ID sequences 15 are offset from the clock sequences 16 in the movement direction of the car 2. Positions of the upper end portion and the lower end portion of the ID sequence 15 are offset from positions of the upper end portion and the lower end portion of the clock sequence 16 in the movement direction of the car 2 by an identical distance to a difference between the positions of the first detection unit 22 and the second detection unit 23. Hence, in this example, the ID sequence 15 and the clock sequence 16 of the detection subject body 11a are disposed at different heights from each other in the movement direction of the car 2, while the ID sequence 15 and the clock sequence 16 of the detection subject body 11b are disposed at different heights from each other and in alignment with the respective heights of the ID sequence 15 and the clock sequence 16 of the detection subject body 11a. All other configurations of the detection subject bodies 11a, 11b are identical to those of the detection subject bodies 11a, 11b according to the tenth embodiment. Further, all configurations other than those of the detectors 21a, 21b and the detection subject bodies 11a, 11b are identical to the tenth embodiment.

By thus disposing the first detection units 22 and the second detection units 23 so as to be offset from each other in the horizontal direction while partially overlapping when the detectors 21a, 21b are seen from above, a space required to dispose the detectors 21a, 21b can be reduced in the horizontal direction while ensuring that an abnormality caused by a fault in the position detection apparatus or the like can be detected.

Note that in the example described above, when the detectors 21a, 21b are seen from above, the first detection units 22 and the second detection units 23 partially overlap in three locations, but it is sufficient for the first detection units 22 and the second detection units 23 to overlap partially in at least one location when the detectors 21a, 21b are seen from above.

### Twelfth Embodiment

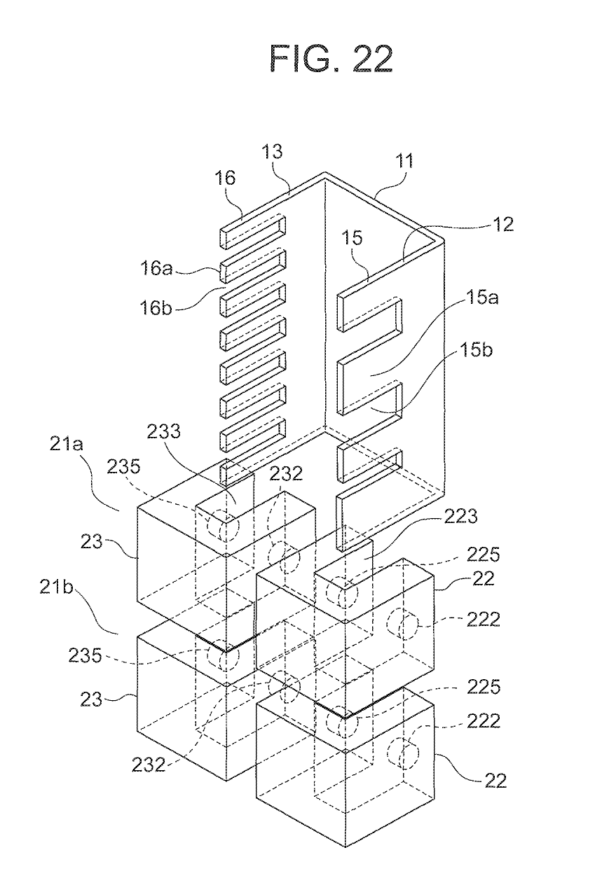

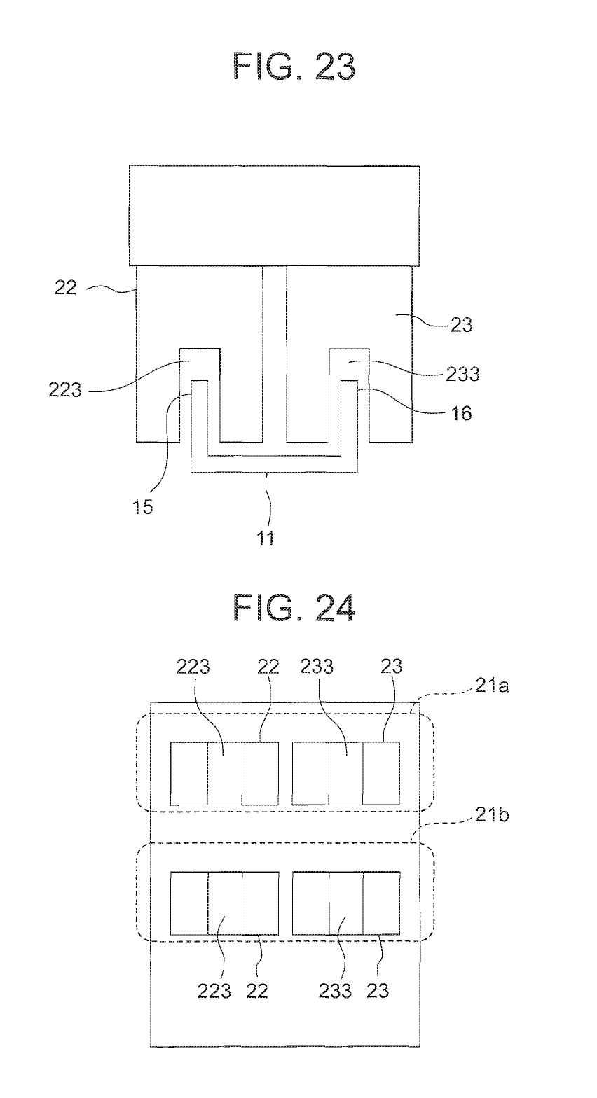

FIG. 22 is a perspective view showing the detection subject body 11 and the detectors 21a, 21b of an elevator position detection apparatus according to a twelfth embodiment of this invention. Further, FIG. 23 is a top view showing the detection subject body 11 and the detectors 21a, 21b of FIG. 22, and FIG. 24 is a front view showing the detectors 21a, 21b of FIG. 22. In the A system and B system detectors 21a, 21b, the first detection units 22 and the second detection units 23 are arranged in the horizontal direction. Further, the A system detector 21a and the B system detector 21b are disposed at a remove from each other in the movement direction of the car 2. In other words, the first detection unit 22 and the second detection unit 23 of the A system detector 21a are disposed at an identical height, while the first detection unit 22 and the second detection unit 23 of the B system detector 21b are disposed at a different height from the height of the A system detector 21a. In this example, the B system detector 21b is disposed below the A system detector 21a. Furthermore, when the detectors 21a, 21b are seen from above, the first detection units 22 of the respective detectors 21a, 21b completely overlap each other, and the second detection units 23 of the respective detectors 21a, 21b completely overlap each other. Accordingly, the first detection grooves 223 also completely overlap each other, and the second detection grooves 233 also completely overlap each other. In this example, when the detectors 21a, 21b are seen from above, the first detection units 22 and the second detection units 23 are arranged such that the first and second detection grooves 223, 233 are respectively aligned in the width direction.

The detection subject body 11, which is configured identically to that of the first embodiment, is fixed singly to each reference position. When the detection subject body 11 fixed to each reference position is seen from above, as shown in FIG. 23, the ID sequence 15 is inserted into the first detection grooves 223 of the respective first detection units 22, and the clock sequence 16 is inserted into the second detection grooves 233 of the respective second detection units 23. Hence, when the car 2 moves such that the respective detectors 21a, 21b pass the reference position, the common ID sequence 15 passes through the first detection grooves 223 of the respective first detection units 22 in sequence, and the common clock sequence 16 passes through the second detection grooves 233 of the respective second detection units 23 in sequence.

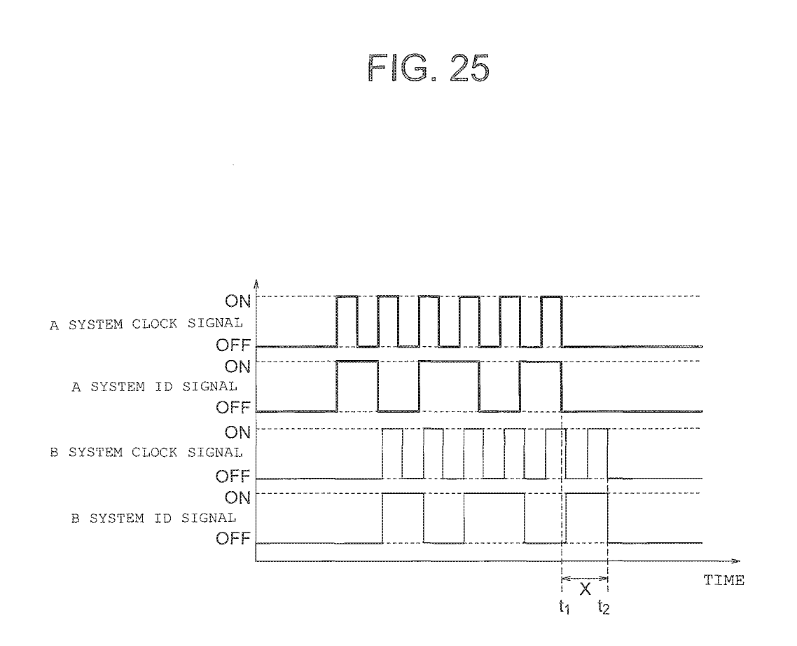

FIG. 25 is a graph comparing temporal variation in the output conditions of the ID signals and clock signals output by the respective detectors 21a, 21b of FIG. 22. Note that in FIG. 25, the ID signal and the clock signal of the A system detector 21a are denoted as an A system ID signal and an A system clock signal, while the ID signal and the clock signal of the B system detector 21b are denoted as a B system ID signal and a B system clock signal. The detection subject body information (in other words, the position information of the ID sequence 15 and the reading information of the clock sequence 16) detected by the A system detector 21a is confirmed at a time t1 corresponding to a final fall time of the A system ID signal and the A system clock signal. The detection subject body information detected by the B system detector 21b is confirmed at a time t2 corresponding to a final fall time of the B system ID signal and the B system clock signal. Hence, when the car 2 descends, the detection subject body information detected by the A system detector 21a is confirmed first, whereupon the detection subject body information detected by the B system detector 21b is confirmed at a delay corresponding to a time difference X between the time t1 and the time t2.

Positions of the car 2 in which the detection subject body information is confirmed by the A system and B system detectors 21a, 21b are stored in the processing unit 31 in advance as car detection confirmation positions. The car detection confirmation positions are learned by moving the car 2 during an elevator fitting operation, a maintenance inspection operation, a periodically performed learning operation, or the like, for example, and then stored in the processing unit 31. When learning the car detection confirmation positions, the processing unit 31 specifies the position of the car 2 using information from a speed governor encoder provided in a speed governor or information from a hoisting machine encoder provided in a hoisting machine.

During a normal elevator operation, the processing unit 31 determines whether or not an abnormality has occurred in the elevator on the basis of the information from the A system and B system detectors 21a, 21b. In other words, during a normal elevator operation, the processing unit 31 determines the actual positions of the car 2 in which the detection subject body information is confirmed by the A system and B system detectors 21a, 21b on the basis of the detection subject body information from the A system and B system detectors 21a, 21b, and determines whether or not an abnormality has occurred in either of the detectors 21a, 21b by comparing the actual positions of the car 2 when the detection subject body information is confirmed with the car detection confirmation positions stored in advance in the processing unit 31. More specifically, during a normal elevator operation, the processing unit 31 determines that an abnormality has not occurred when the actual positions of the car 2 upon confirmation of the detection subject body information by the A system and B system detectors 21a, 21b match the car detection confirmation positions, and determines that an abnormality has occurred when the actual positions of the car 2 upon confirmation of the detection subject body information by the A system and B system detectors 21a, 21b differ from the car detection confirmation positions. All other configurations and operations are identical to the tenth embodiment.

By thus disposing the first detection units 22 of the respective detectors 21a, 21b to overlap each other completely and disposing the second detection units 23 of the respective detectors 21a, 21b to overlap each other completely when the detectors 21a, 21b are seen from above, the space required to dispose the detectors 21a, 21b can be reduced in the horizontal direction even further while still ensuring that an abnormality caused by a fault in the position detection apparatus or the like can be detected. Moreover, the common ID sequence 15 and the common clock sequence 16 can be passed through the first detection grooves 223 and the second detection grooves 233, respectively, and therefore the detection subject body 11 can be shared by the detectors 21a, 21b, enabling a reduction in the number of components of the position detection apparatus.

Note that in the example described above, the determination as to whether or not an abnormality has occurred is made by comparing the positions of the car 2 at the detection confirmation times t1, t2 of the A system and B system detectors 21a, 21b with the car detection confirmation positions stored in advance in the processing unit 31, but instead, information indicating an attachment interval between the A system and B system detectors 21a, 21b (in other words, a distance between horizontal center lines of the A system and B system detectors 21a, 21b) may be stored in advance in the processing unit 31, and the determination as to whether or not an abnormality has occurred may be made by comparing a distance corresponding to the time difference X between the detection confirmation times t1, t2 of the A system and B system detectors 21a, 21b with the attachment interval between the detectors 21a, 21b, stored in advance in the processing unit 31.

Further, the processing unit 31 may correct the time difference X between the time t1 and the time t2 so that the A system ID signal and the A system clock signal can be compared with the B system ID signal and the B system clock signal, respectively, and may then determine whether or not an abnormality has occurred by comparing the respective ID signals with each other and comparing the respective clock signals with each other in a similar manner to the tenth embodiment.

### Thirteenth Embodiment

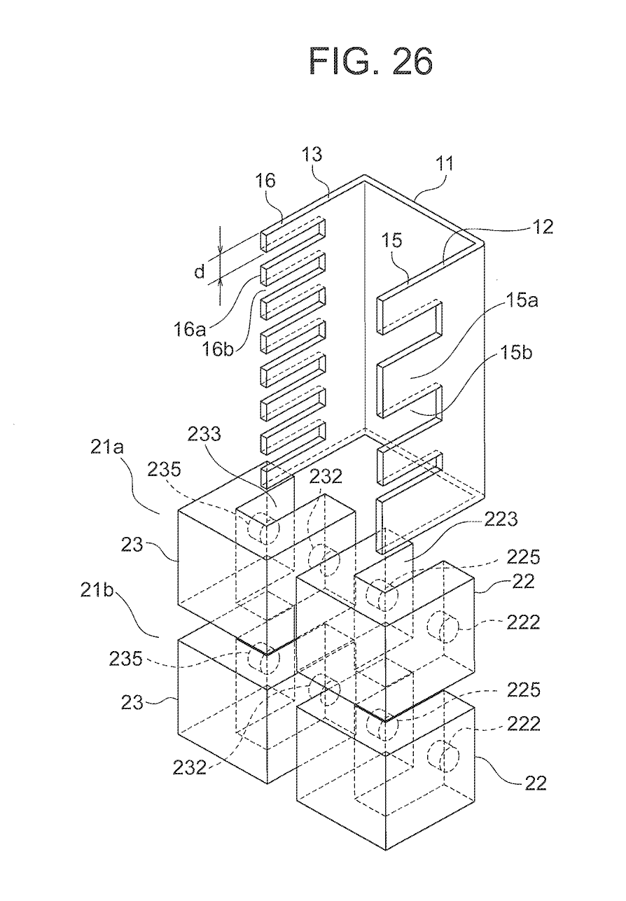

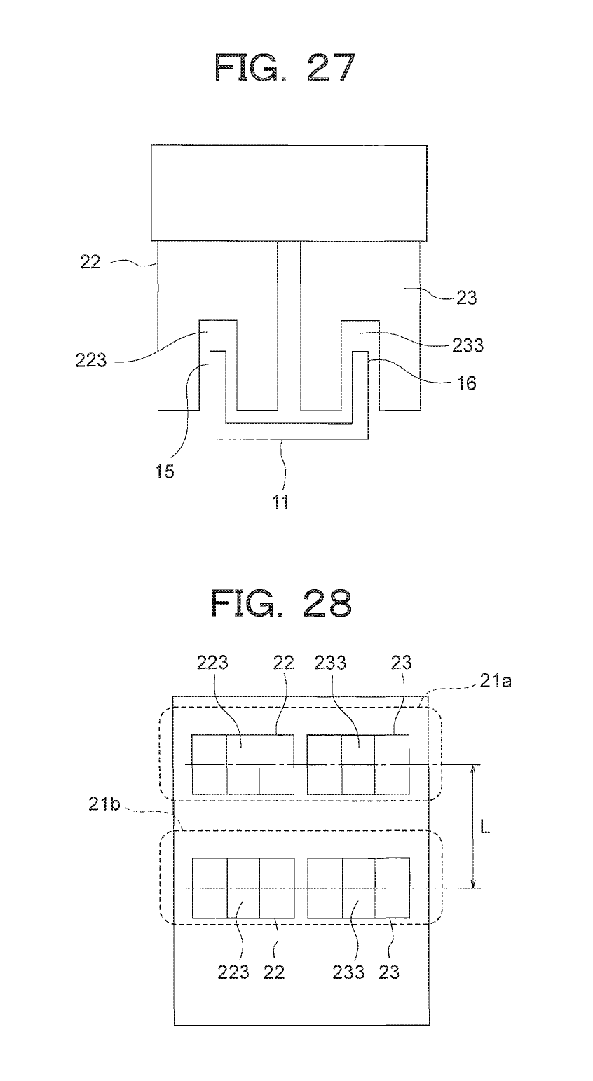

FIG. 26 is a perspective view showing the detection subject body 11 and the detectors 21a, 21b of an elevator position detection apparatus according to a thirteenth embodiment of this invention. Further, FIG. 27 is a top view showing the detection subject body 11 and the detectors 21a, 21b of FIG. 26, and FIG. 28 is a front view showing the detectors 21a, 21b of FIG. 26. In the clock sequence 16, the low resistance portions 16a and the high resistance portions 16b all have an identical dimension (referred to hereafter as a “clock width”) d in the movement direction of the car 2. An attachment interval L (FIG. 28) between the A system and B system detectors 21a, 21b (in other words, the distance between the horizontal center lines of the A system and B system detectors 21a, 21b) is set as an integral multiple no smaller than 1 of the clock width d. The processing unit 31 determines whether or not an abnormality has occurred due to a fault in the position detection apparatus or the like by comparing the A system clock signal and the B system clock signal serving as the information obtained respectively from the A system and B system detectors 21a, 21b.

More specifically, when the attachment interval L between the A system and B system detectors 21a, 21b is an even number multiple of the clock width d, the A system clock signal and the B system clock signal are always output in identical forms by the respective detectors 21a, 21b. When the attachment interval L between the A system and B system detectors 21a, 21b is an odd number multiple of the clock width d, on the other hand, the A system clock signal and the B system clock signal are always output in inverted forms by the respective detectors 21a, 21b. The processing unit 31 determines whether or not an abnormality has occurred due to a fault in the position detection apparatus or the like by monitoring the A system clock signal and the B system clock signal to determine whether or not the A system clock signal and the B system clock signal are identical to each other when the attachment interval L is an even number multiple of the clock width d, and by monitoring the A system clock signal and the B system clock signal to determine whether or not the A system clock signal and the B system clock signal are inverted relative to each other when the attachment interval L is an odd number multiple of the clock width d. All other configurations and operations are identical to the twelfth embodiment.

By setting the attachment interval L between the A system and B system detectors 21a, 21b as an integral multiple no smaller than 1 of the clock width d in this manner, the clock signals can be output in either identical forms or inverted forms by the A system detector 21a and the B system detector 21b. Hence, by comparing the clock signals from the A system and B system detectors 21a, 21b, the presence of an abnormality due to a fault in the position detection apparatus or the like can be determined easily.

### Fourteenth Embodiment

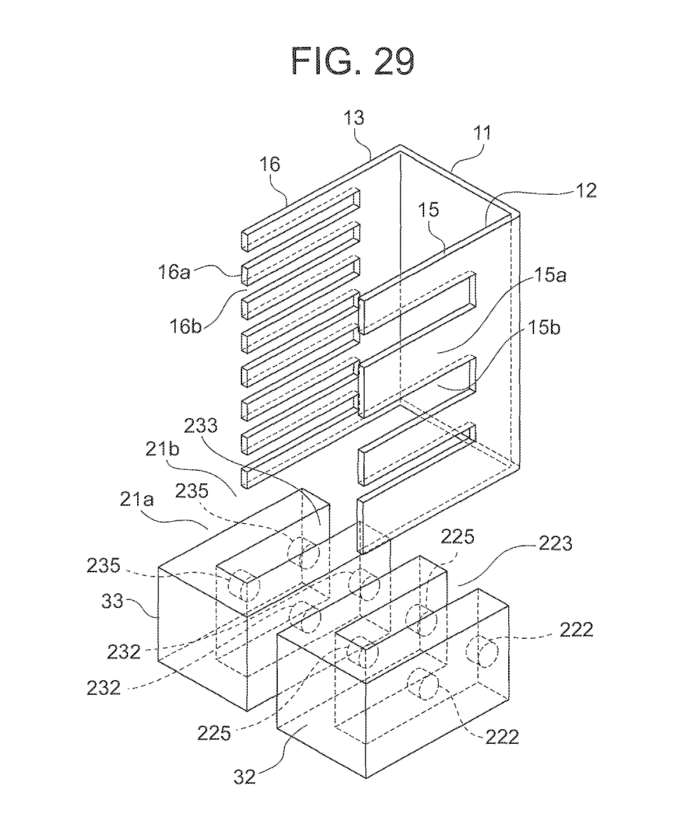

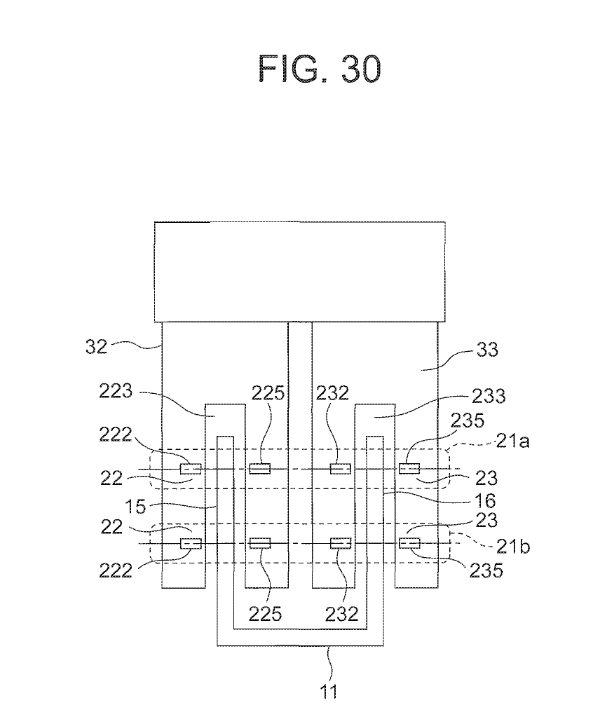

FIG. 29 is a perspective view showing the detection subject body 11 and the detectors 21a, 21b of an elevator position detection apparatus according to a fourteenth embodiment of this invention, and FIG. 30 is a top view showing the detection subject body 11 and the detectors 21a, 21b of FIG. 29. A first support portion 32 serving as the first housing and a second support portion 33 serving as the second housing are provided in the car 2 and arranged in the horizontal direction. The first detection groove 223 is provided in the first support portion 32 so as to extend in the movement direction of the car 2, and the second detection groove 233 is provided in the second support portion 33 so as to extend in the movement direction of the car 2. The first support portion 32 is provided in the car 2 such that a depth direction of the first detection groove 223 is aligned with the planar direction of the first detection subject plate 12. The second support portion 33 is provided in the car 2 such that a depth direction of the second detection groove 233 is aligned with the planar direction of the second detection subject plate 13.

The respective first detection units 22 of the A system and B system detectors 21a, 21b are provided in a common first support portion 32. The first detection units 22 are disposed at a remove from each other in the depth direction of the first detection groove 223. In each first detection unit 22, the first magnetic field generating coil 222 and the first magnetic field detecting coil 225 are disposed opposite each other on either side of the first detection groove 223. As a result, first detection regions in which high frequency magnetic fields are generated in response to energization of the first magnetic field generating coils 222 are formed in the first detection groove 223 at a remove from each other in the depth direction of the first detection groove 223.

The respective second detection units 23 of the A system and B system detectors 21a, 21b are provided in a common second support portion 33. The second detection units 23 are disposed at a remove from each other in the depth direction of the second detection groove 233. In each second detection unit 23, the second magnetic field generating coil 232 and the second magnetic field detecting coil 235 are disposed opposite each other on either side of the second detection groove 233. As a result, second detection regions in which high frequency magnetic fields are generated in response to energization of the second magnetic field generating coils 232 are formed in the second detection groove 233 at a remove from each other in the depth direction of the second detection groove 233.

When the detection subject body 11 is seen from above, the ID sequence 15 is inserted into the first detection groove 223 and the clock sequence 16 is inserted into the second detection groove 233. A dimension of the ID sequence 15 in the depth direction of the first detection groove 223 is set to be large enough to intersect the respective positions of both of the first detection units 22. A dimension of the clock sequence 16 in the depth direction of the second detection groove 233 is set to be large enough to intersect the respective positions of both of the second detection units 23.

When the A system and B system detectors 21a, 21b pass the position of the detection subject body 11, the common ID sequence 15 passes through the two first detection regions formed in the first detection groove 223, and the common clock sequence 16 passes through the two second detection regions formed in the second detection groove 233. As a result, the detection subject body information detected by the A system and B system detectors 21a, 21b is confirmed simultaneously, whereupon the ID signal and the clock signal are transmitted simultaneously from the A system and B system detectors 21a, 21b to the processing unit 31.

Similarly to the twelfth embodiment, the processing unit 31 determines whether or not an abnormality has occurred in the respective detectors 21a, 21b by comparing the position of the car 2 at the point where the A system and B system detectors 21a, 21b confirm the detection subject body information with the car detection confirmation positions stored in advance in the processing unit 31. All other configurations and operations are identical to the twelfth embodiment.

By providing the first detection units 22 in the common first support portion 32 and providing the second detection units 23 in the common second support portion 33 in this manner, a support structure for supporting the plurality of first magnetic field generating coils 222 and the plurality of first detection units 22 can be provided by the common first support portion 32, and a support structure for supporting the plurality of second detection units 23 can be provided by the common second support portion 33. As a result, reductions can be achieved in the number of components and the space required to dispose the detectors 21a, 21b.

### Fifteenth Embodiment

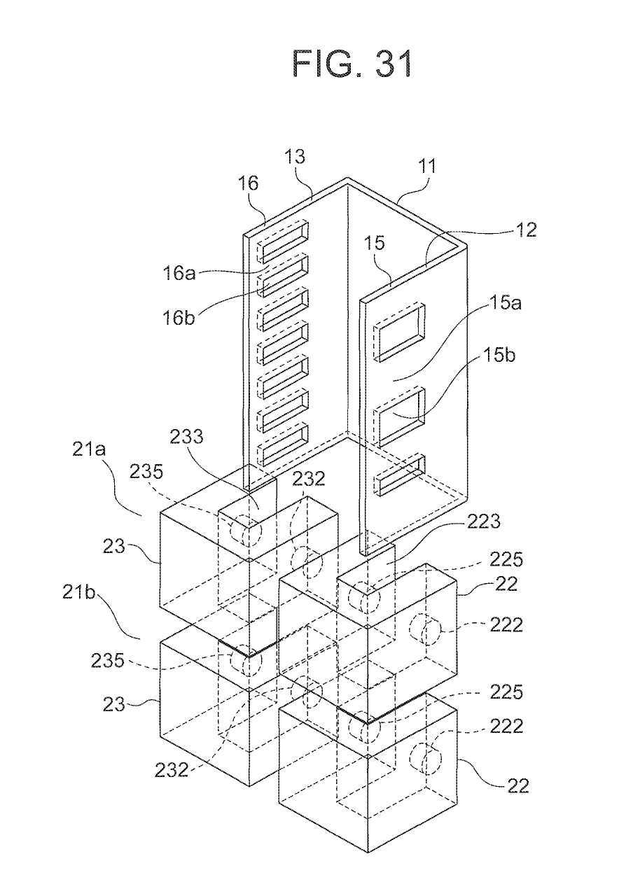

FIG. 31 is a perspective view showing the detection subject body 11 and the detectors 21a, 21b of an elevator position detection apparatus according to a fifteenth embodiment of this invention. In the detection subject body 11, the high resistance portions 15b of the ID sequence 15 and the high resistance portions 16b of the clock sequence 16 are all constituted by through-hole portions taking the form of rectangular space portions having an entirely closed circumference, rather than slits open at one end. In other words, the first detection subject plate 12 and the second detection subject plate 13 of the detection subject body 11 are both formed from perforated plates. All other configurations and operations are identical to the twelfth embodiment.

By forming the high resistance portions 15b of the ID sequence 15 and the high resistance portions 16b of the clock sequence 16 from space portions having an entirely closed circumference in this manner, the first and second detection subject plates 12, 13 can be strengthened, leading to an improvement in the durability of the detection subject body 11. Further, an elongated component suspended from the car 2, such as the main cable 4, for example, is less likely to become caught on the detection subject body 11, and therefore malfunctions can be prevented from occurring in the elevator.

### Sixteenth Embodiment

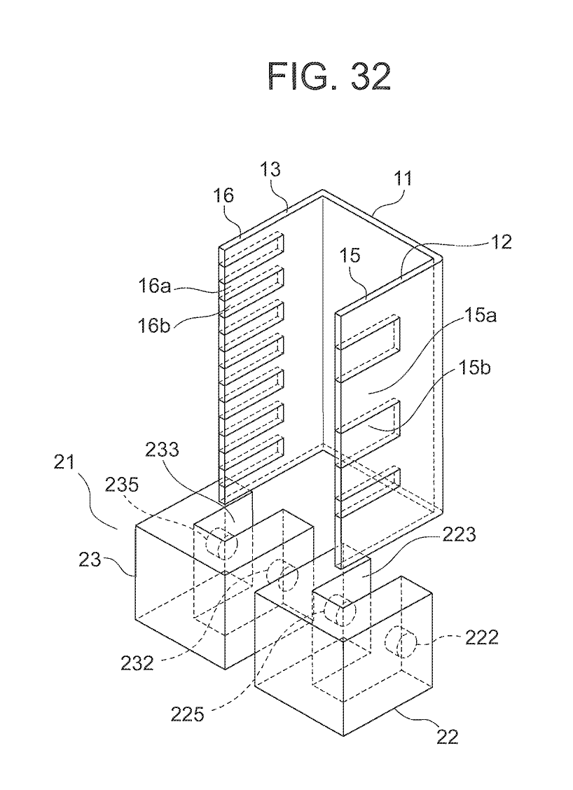

FIG. 32 is a perspective view showing the detection subject body 11 and the detectors 21a, 21b of an elevator position detection apparatus according to a sixteenth embodiment of this invention. In the detection subject body 11, the high resistance portions 15b of the ID sequence 15 and the high resistance portions 16b of the clock sequence 16 are members having a physical form. The physical members serving as the high resistance portions 15b, 16b are formed from a material (resin, plastic, or the like, for example) that is less likely to generate an eddy current than the metal forming the first and second detection subject plates 12, 13. In this example, a plurality of slits that are open at one end are formed in the first and second detection subject plates 12, 13, whereupon the physical members serving as the high resistance portions 15b, 16b are fitted respectively into the slits. In other words, the spaces formed by the slits in the first and second detection subject plates 12, 13 are filled with the physical members serving as the high resistance portions 15b, 16b. All other configurations and operations are identical to the first embodiment.

By forming the high resistance portions 15b, 16b from physical members in this manner, the first and second detection subject plates 12, 13 can be strengthened, leading to an improvement in the durability of the detection subject body 11. Further, an elongated component suspended from the car 2, such as the main cable 4, for example, is less likely to become caught on the detection subject body 11, and therefore malfunctions can be prevented from occurring in the elevator.

Note that although the configuration in which the high resistance portions 15b of the ID sequence 15 and the high resistance portions 16b of the clock sequence 16 are formed from members having a physical form is applied to the detection subject body 11 according to the first embodiment in the example described above, the configuration in which the high resistance portions 15b of the ID sequence 15 and the high resistance portions 16b of the clock sequence 16 are formed from members having a physical form may be applied likewise to the detection subject bodies 11, 11a, 11b according to the second to fifteenth embodiments.

### Seventeenth Embodiment

In the first embodiment, the position information and reading information set respectively in the ID sequence 15 and clock sequence 16 are detected by the eddy current type detector 21, but the position information and reading information set respectively in the ID sequence 15 and clock sequence 16 may be detected by an optical detector.

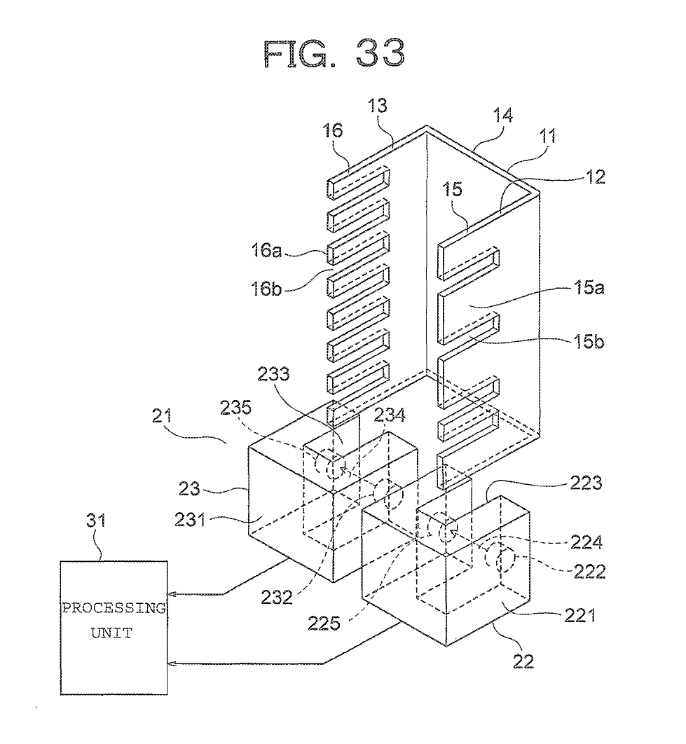

FIG. 33 is a perspective view showing an elevator position detection apparatus according to a seventeenth embodiment of this invention. The detection subject body 11 is configured identically to the detection subject body 11 according to the first embodiment. In the ID sequence 15 of the detection subject body 11, the low resistance portions 15a serving as the first property portions are constituted by light blocking portions formed from a metallic material that has a property for blocking the passage of light, while the high resistance portions 15b serving as the second property portions are constituted by light transmitting portions formed from spaces through which light passes easily in comparison with the light blocking portions 15a. Likewise in the clock sequence 16 of the detection subject body 11, the low resistance portions 16a serving as the first property portions are constituted by light blocking portions formed from a metallic material that has a property for blocking the passage of light, while the high resistance portions 16b serving as the second property portions are constituted by light transmitting portions formed from spaces through which light passes easily in comparison with the light blocking portions 16a. In other words, in the ID sequence 15 and the clock sequence 16, the light blocking portions 15a, 16a serving as the first property portions and the light transmitting portions 15b, 16b serving as the second property portions differ from each other in the respective light-related properties thereof.

The detector 21 includes the first detection unit 22, which employs an optical system to detect the position information set in the ID sequence 15 of the first detection subject plate 12, and the second detection unit 23, which employs an optical system to detect the reading information set in the clock sequence 16 of the second detection subject plate 13.

The first detection unit 22 includes the first support portion 221 fixed to the car 2, and a first light emitting portion 222 and a first light receiving portion 225 provided respectively in the first support portion 221. The first light emitting portion 222 and the first light receiving portion 225 are disposed opposite each other on either side of the first detection groove 223 provided in the first support portion 221. The first detection region 224 is formed in the first detection groove 223. The first light emitting portion 222 emits light that passes through the first detection region 224. The first light receiving portion 225 receives the light that passes through the first detection region 224 after being emitted from the first light emitting portion 222.

The second detection unit 23 includes the second support portion 231 fixed to the car 2, and a second light emitting portion 232 and a second light receiving portion 235 provided respectively in the second support portion 231. The second light emitting portion 232 and the second light receiving portion 235 are disposed opposite each other on either side of the second detection groove 233 provided in the second support portion 231. The second detection region 234 is formed in the second detection groove 233. The second light emitting portion 232 emits light that passes through the second detection region 234. The second light receiving portion 235 receives the light that passes through the second detection region 234 after being emitted from the second light emitting portion 232.

When the ID sequence 15 passes through the first detection region 224, the light from the first light emitting portion 222 is blocked in the positions of the light blocking portions 15a such that no light reaches the first light receiving portion 225, whereas the light from the first light emitting portion 222 passes through the positions of the light transmitting portions 15b such that light reaches the first light receiving portion 225. Hence, the first detection unit 22 detects the light passing through the ID sequence 15 using the first light receiving portion 225 when the ID sequence 15 passes through the first detection region 224, and outputs a time series signal having a different output condition depending on whether or not light is passed (i.e. depending on variation in an amount of passing light) as the ID signal. In other words, when the ID sequence 15 passes through the first detection region 224, the first detection unit 22 outputs a time series signal having an output condition that switches in accordance with the arrangement pattern of the light blocking portions 15a and the light transmitting portions 15b of the ID sequence 15 (i.e. a time series signal having an output condition that switches in the boundary positions between the light blocking portions 15a and the light transmitting portions 15b of the ID sequence 15) as the ID signal.

When the clock sequence 16 passes through the second detection region 234, the light from the second light emitting portion 232 is blocked in the positions of the light blocking portions 16a such that no light reaches the second light receiving portion 235, whereas the light from the second light emitting portion 222 passes through the positions of the light transmitting portions 16b such that light reaches the second light receiving portion 235. Hence, the second detection unit 23 detects the light passing through the clock sequence 16 using the second light receiving portion 235 when the clock sequence 16 passes through the second detection region 234, and outputs a time series signal having a different output condition depending on whether or not light is passed (i.e. depending on variation in the amount of passing light) as the clock signal. In other words, when the clock sequence 16 passes through the second detection region 234, the second detection unit 23 outputs a time series signal having an output condition that switches in accordance with the arrangement pattern of the light blocking portions 16a and the light transmitting portions 16b of the clock sequence 16 (i.e. a time series signal having an output condition that switches in the boundary positions between the light blocking portions 16a and the light transmitting portions 16b of the clock sequence 16) as the clock signal. All other configurations and operations are identical to the first embodiment.

Therefore, similar effects to those obtained by eddy current type detection units can be obtained when the first detection unit 22 and the second detection unit 23 are formed from optical detection units.

Note that in the example described above, the light transmitting portions 15b, 16b are formed as spaces, but the light transmitting portions 15b, 16b may be formed from physical members that fill spaces provided in the first and second detection subject plates 12, 13. In this case, the physical members serving as the light transmitting portions 15b, 16b are formed from a material (transparent plastic or the like, for example) through which light passes easily in comparison with the light blocking portions 15a, 16a.

Further, in the example described above, the light blocking portions 15a, 16a are formed from a metallic material, but may be formed from a material (resin, plastic, or the like, for example) other than metal.

Furthermore, in the example described above, optical detection units are applied to the first and second detection units 22, 23 according to the first embodiment, but optical detection units may also be applied to the first and second detection units 22, 23 according to the second to sixteenth embodiments. When optical detection units are applied to the first and second detection units 22, 23 according to the sixteenth embodiment, the physical members serving as the light transmitting portions 15b, 16b are formed from a material (transparent plastic or the like, for example) through which light passes easily in comparison with the light blocking portions 15a, 16a.

Moreover, in the example described above, the respective first property portions of the ID sequence 15 and the clock sequence 16 are formed from the light blocking portions 15a, 16a, which have a property for blocking the passage of light completely, but this invention is not limited thereto, and as long as the first property portions and the second property portions pass different amounts of light such that a difference in the amount of received light passing through the first property portions and the second property portions can be detected by the first and second light receiving portions 225, 235, members having a property for partially transmitting light may be used as the first property portions.

Further, in the tenth to fifteenth embodiments described above, the detection subject body 11 and the detector 21 according to the first embodiment are duplicated, but the detection subject body 11 and the detector 21 according to the second to ninth embodiments may also be duplicated. Further, the detection subject bodies 11a, 11b and the detectors 21a, 21b are respectively doubled, but three or more detection subject bodies and three or more detectors may be provided instead.

Furthermore, in the above embodiments, the high resistance portions 15b, 16b are formed as spaces, but the spaces forming the high resistance portions 15b, 16b may be filled with an insulating material (resin, plastic, or the like, for example).

Moreover, the configuration of the third embodiment, in which the ID sequence 15 and the clock sequence 16 are offset from each other in the movement direction of the car 2, may be applied likewise to the detection subject bodies 11, 11a, 11b according to the second, fourth to sixth, eighth to tenth, and twelfth to seventeenth embodiments.

Furthermore, the configuration of the seventh embodiment, in which the first and second detection regions 224, 234 are offset from each other in the movement direction of the car 2, may be applied likewise to the detectors 21, 21a, 21b according to the second, fourth to sixth, eighth to tenth, and twelfth to seventeenth embodiments.

Moreover, the configuration of the sixth embodiment, in which the high resistance portions 15b, 16b are provided in the ID sequence 15 and the clock sequence 16 by forming the plurality of punch holes 43 in the first and second detection subject plates 12, 13, may be applied likewise to the detection subject body 11 according to the first to fourth and seventh to seventeenth embodiments. Furthermore, in the first to sixteenth embodiments, the configuration in which the high resistance portions are provided by forming the plurality of punch holes 43 may be applied to only one of the ID sequence 15 and the clock sequence 16 while applying through-hole portions (opening portions) or slits to the other.

Further, the configuration of the fifth embodiment, in which rectangular through-hole portions are provided in the first and second detection subject plates 12, 13, may be applied to the detection subject bodies 11, 11a, 11b according to the first, third, fourth, seventh to fourteenth, sixteenth, and seventeenth embodiments, in which the first and second detection subject plates 12, 13 are disposed parallel to each other.

1. An elevator position detection apparatus, comprising:
a detection subject body that is provided in a hoistway and includes a first detection subject plate and a second detection subject plate, the first detection subject plate being provided with an ID sequence formed by arranging a first property portion and a second property portion having a different property from the first property portion in a movement direction of an elevating body in an arrangement pattern that corresponds to a position within the hoistway, and the second detection subject plate being provided with a clock sequence formed by arranging a first property portion and a second property portion having a different property from the first property portion in the movement direction of the elevating body;
a detector that is provided in the elevating body and includes a first detection unit and a second detection unit, the first detection unit being provided with a first detection region so as to output, as an ID signal, a time series signal having an output condition that switches in a boundary position between the first property portion and the second property portion of the ID sequence when the ID sequence passes through the first detection region, and the second detection unit being provided with a second detection region so as to output, as a clock signal, a time series signal having an output condition that switches in a boundary position between the first property portion and the second property portion of the clock sequence when the clock sequence passes through the second detection region; and
a processing unit that specifies a position of the elevating body within the hoistway by reading the output condition of the ID signal in a position where the output condition of the clock signal switches.

2. The elevator position detection apparatus according to claim 1, wherein
the second property portion of the ID sequence has a property of being less likely to generate an eddy current than the first property portion of the ID sequence,
the second property portion of the clock sequence has a property of being less likely to generate an eddy current than the first property portion of the clock sequence, and
the first detection unit and the second detection unit are respectively formed from eddy current type detection units.

3. The elevator position detection apparatus according to claim 2, wherein a space formed in at least one of the respective second property portions of the ID sequence and the clock sequence is constituted by a plurality of punch holes.

4. The elevator position detection apparatus according to claim 1, wherein
the second property portion of the ID sequence has a property of being more capable of transmitting light than the first property portion of the ID sequence,
the second property portion of the clock sequence has a property of being more capable of transmitting light than the first property portion of the clock sequence, and
the first detection unit and the second detection unit are respectively formed from optical type detection units.

5. The elevator position detection apparatus according to claim 1, wherein the first detection subject plate and the second detection subject plate are disposed parallel to each other.

6. The elevator position detection apparatus according to claim 1, wherein the first detection subject plate and the second detection subject plate are formed integrally on an identical plane extending in the movement direction of the elevating body.

7. The elevator position detection apparatus according to claim 1, wherein the first detection unit and the second detection unit are formed integrally.

8. The elevator position detection apparatus according to claim 1, wherein a timing at which the output condition of the ID signal switches is offset from a timing at which the output condition of the clock signal switches.

9. The elevator position detection apparatus according to claim 8, wherein the boundary position between the first property portion and the second property portion of the ID sequence is offset from the boundary position between the first property portion and the second property portion of the clock sequence in the movement direction of the elevating body.

10. The elevator position detection apparatus according to claim 8, wherein respective positions of the first detection region and the second detection region are offset from each other in the movement direction of the elevating body.

11. The elevator position detection apparatus according to claim 1, wherein the processing unit determines the movement direction of the elevating body on the basis of information from an encoder that outputs a signal corresponding to a movement of the elevating body, and specifies the position of the elevating body within the hoistway on the basis of the information indicating the determined movement direction, the ID signal, and the clock signal.

12. The elevator position detection apparatus according to claim 1, wherein
an upper end identification portion is provided on an upper end portion of each of the ID sequence and the clock sequence,
a lower end identification portion is provided on a lower end portion of each of the ID sequence and the clock sequence,
when the upper end identification portion and the lower end identification portion are compared, the upper end identification portion and the lower end identification portion differ from each other in either a dimension of the first property portion in the movement direction of the elevating body or the arrangement pattern of the first property portion and the second property portion,
upper end identification information that corresponds to the upper end identification portion and lower end identification information that corresponds to the lower end identification portion and is different from the upper end identification information are included respectively in the ID signal and the clock signal, and
the processing unit specifies the movement direction of the elevating body on the basis of the upper end identification information and the lower end identification information.

13. The elevator position detection apparatus according to claim 1, wherein
the detection subject body is provided in a plurality in a common position in the movement direction of the elevating body,
the detector is provided in the elevating body in a plurality corresponding to the plurality of detection subject bodies, and
the processing unit determines whether or not an abnormality has occurred in an elevator on the basis of information from each of the detectors.

14. The elevator position detection apparatus according to claim 1, wherein the detection subject body is provided singly in a common position in the movement direction of the elevating body,
the detector is provided in the elevating body in a plurality corresponding to the single detection subject body, and
the processing unit determines whether or not an abnormality has occurred in an elevator on the basis of information from each of the detectors.

15. The elevator position detection apparatus according to claim 14, wherein
the first property portion and the second property portion of the clock sequence respectively have identical clock width dimensions in the movement direction of the elevating body,
the respective detectors are disposed at a remove from each other in the movement direction of the elevating body, and
an attachment interval between the detectors is set at an integral multiple no smaller than 1 of the clock width.

16. The elevator position detection apparatus according to claim 14, wherein
the first detection units of the respective detectors are provided in a common first support portion provided in the elevating body, and
the second detection units of the respective detectors are provided in a common second support portion provided in the elevating body.
